(19) United States
(12) Patent Application Publication
(10) Pub. No.: US 2018/0376497 A1
(43) Pub. Date: Dec. 27, 2018

(54) CONTROL INFORMATION RECEPTION METHOD AND USER EQUIPMENT, AND CONTROL INFORMATION TRANSMISSION METHOD AND BASE STATION

(71) Applicant: LG ELECTRONICS INC., Seoul (KR)

(72) Inventors: Hyangsun YOU, Seoul (KR); Yunjung YI, Seoul (KR); Kijun KIM, Seoul (KR); Ilmu BYUN, Seoul (KR)

(73) Assignee: LG ELECTRONICS INC., Seoul (KR)

(21) Appl. No.: 15/747,028

(22) PCT Filed: Jul. 25, 2016
(86) PCT No.: PCT/KR2016/008093

§ 371 Date: Jan. 23, 2018

Related U.S. Application Data
(60) Provisional application No. 62/196,302, filed on Jul. 24, 2015.
(60) Provisional application No. 62/288,443, filed on Jan. 29, 2016.
(60) Provisional application No. 62/325,421, filed on Apr. 20, 2016.
(60) Provisional application No. 62/335,640, filed on May 12, 2016.

(51) Int. Cl. H04W 72/12; H04W 72/04; H04W 72/14; H04L 5/00; H04W 74/08

(52) U.S. Cl. CPC H04W 72/1294; H04W 72/042; H04W 72/1284; H04W 74/0808; H04L 5/0055; H04L 5/001; H04W 72/14

(57) ABSTRACT

Provided are method and device for transmitting/receiving control information. A downlink grant can comprise information indicating whether or not an uplink grant is transmitted in the same subframe. If the information indicates that an uplink grant exists, a user equipment attempts detection of the uplink grant in the same subframe in which the downlink grant is received. If not, the user equipment does not attempt detection of the uplink grant. For low latency, the subframe can be shorter than an existing subframe.

### TECHNICAL FIELD

The present invention relates to a wireless communication system and, more particularly, to a method for transmitting or receiving control information and an apparatus therefor.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed.

A general wireless communication system performs data transmission/reception through one downlink (DL) band and through one uplink (UL) band corresponding to the DL band (in case of a frequency division duplex (FDD) mode), or divides a prescribed radio frame into a UL time unit and a DL time unit in the time domain and then performs data transmission/reception through the UL/DL time unit (in case of a time division duplex (TDD) mode). A base station (BS) and a user equipment (UE) transmit and receive data and/or control information scheduled on a prescribed time unit basis, e.g. on a subframe basis. The data is transmitted and received through a data region configured in a UL/DL subframe and the control information is transmitted and received through a control region configured in the UL/DL subframe. To this end, various physical channels carrying radio signals are formed in the UL/DL subframe. In contrast, carrier aggregation technology serves to use a wider UL/DL bandwidth by aggregating a plurality of UL/DL frequency blocks in order to use a broader frequency band so that more signals relative to signals when a single carrier is used can be simultaneously processed.

In addition, a communication environment has evolved into increasing density of nodes accessible by a user at the periphery of the nodes. A node refers to a fixed point capable of transmitting/receiving a radio signal to/from the UE through one or more antennas. A communication system including high-density nodes may provide a better communication service to the UE through cooperation between the nodes.

### DISCLOSURE

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

The technical objects that can be achieved through the present invention are not limited to what has been particularly described hereinabove and other technical objects not described herein will be more clearly understood by persons skilled in the art from the following detailed description.

### Technical Solution

A method and apparatus for transmitting/receiving control information are provided. Information indicating whether an uplink grant is transmitted or not within the same subframe may be included in a downlink grant. If the information indicates that the uplink grant is present, a user equipment (UE) attempts to detect the uplink grant within the same subframe in which a downlink grant is received and, if not, the UE does not attempt to detect the uplink grant. For low latency, the subframe may be a shortened subframe having a length shorter than a legacy subframe.

According to an aspect of the present invention, provided herein is a method of receiving control information by a UE. The method may include receiving a downlink grant in a subframe n; and receiving downlink data in the subframe n according to the downlink grant. The downlink grant may include uplink grant information indicating whether or not an uplink grant is present, and

In another aspect of the present invention, provided herein is a UE for receiving control information. The UE may include a radio frequency (RF) unit and a processor connected to the RF unit. The processor may be configured to control the RF unit to receive a downlink grant in a subframe n; and control the RF unit to receive downlink data in the subframe n according to the downlink grant. The downlink grant may include uplink grant information indicating whether or not an uplink grant is present.

In another aspect of the present invention, provided herein is a method of transmitting control information by a base station (BS). The method may include transmitting a downlink grant in a subframe n to a UE; and transmitting downlink data in the subframe n to the UE according to the downlink grant. The downlink grant may include uplink grant information indicating whether or not an uplink grant is present.

In another aspect of the present invention, provided herein is a BS for transmitting control information. The BS may include an RF unit and a processor connected to the RF unit. The processor may be configured to control the RF unit to transmit a downlink grant in a subframe n to a UE; and control the RF unit to transmit downlink data in the subframe n to the UE according to the downlink grant. The downlink grant may include uplink grant information indicating whether or not an uplink grant is present.

In each aspect of the present invention, if the uplink grant information indicates that the uplink grant is present, the BS may transmit the uplink grant to the UE in the subframe n. If the uplink grant information indicates that the uplink grant is not present, the BS may not transmit the uplink grant to the UE in the subframe n.

In each aspect of the present invention, if the uplink grant information indicates that the uplink grant is present, the UE may attempt to detect the uplink grant to the UE in the subframe n. If the uplink grant information indicates that the uplink grant is not present, the UE may not expect to receive the uplink grant in the subframe n. If the uplink grant information indicates that the uplink grant is not present, the UE may not attempt to detect the uplink grant in the subframe n.

In each aspect of the present invention, the BS may transmit the uplink grant within a candidate resource associated with a transmission resource of the downlink grant.

In each aspect of the present invention, the UE may attempt to detect the uplink grant within a candidate resource associated with a reception resource of the downlink grant.

In each aspect of the present invention, if the uplink grant information indicates that the uplink grant is present but detection of the uplink grant fails, the UE may determine that the downlink grant for scheduling the downlink data is not valid.

In each aspect of the present invention, the BS may rate-match or puncture the downlink data on a candidate resource of the uplink grant (regardless of whether the uplink grant is actually transmitted or not).

In each aspect of the present invention, if the uplink grant information indicates that the uplink grant is present but detection of the uplink grant fails, the UE may assume that the downlink data is rate-matched or punctured on a candidate resource of the uplink grant.

In each aspect of the present invention, the subframe n may be a shortened subframe consisting of partial orthogonal frequency division multiplexing (OFDM) symbols among OFDM symbols within a subframe of 1 ms.

The above technical solutions are merely some parts of the embodiments of the present invention and various embodiments into which the technical features of the present invention are incorporated can be derived and understood by persons skilled in the art from the following detailed description of the present invention.

### Advantageous Effect

According to the present invention, uplink/downlink signals can be efficiently transmitted/received. Therefore, overall throughput of a wireless communication system is improved.

According to an embodiment of the present invention, a low-price/low-cost UE can communicate with a BS while maintaining compatibility with a legacy system.

According to an embodiment of the present invention, a UE can be implemented with low price/low cost.

According to an embodiment of the present invention, coverage can be enhanced.

According to an embodiment of the present invention, a UE and an eNB can communicate in a narrowband.

According to an embodiment of the present invention, delay/latency occurring during communication between a user equipment and a base station may be reduced.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a DL subframe used in a wireless communication system.

FIG. 4 illustrates the structure of a UL subframe used in a wireless communication system.

FIG. 5 is an example of a downlink control channel configured in a data region of a DL subframe.

FIG. 6 illustrates the length of a transmission time interval (TTI) which is needed to implement low latency.

FIG. 7 illustrates an example of a shortened TTI and an example of transmission of a control channel and a data channel in a shortened TTI.

FIG. 8 illustrates an example of allocation of a resource for a control channel within an sTTI.

FIG. 9 illustrates a frequency resource for transmitting a shortened PDSCH (sPDSCH) according to an embodiment of the present invention.

FIG. 10 illustrates a frequency resource for transmitting an sPDSCH according to another embodiment of the present invention.

FIGS. 11 and 12 illustrate time resources for transmission of an sPDSCH.

FIG. 13 illustrates multiplexing of an sPDCCH and an sPDSCH according to an embodiment of the present invention.

FIG. 14 is a block diagram illustrating elements of a transmitting device 10 and a receiving device 20 for implementing the present invention.

### MODE FOR INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmitting device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmitting devices always sense carrier of a network and, if the network is empty, the transmitting devices wait for determined time according to locations thereof registered in a list and then transmit data. Various methods are used to determine priority of the transmitting devices in the list and to reconfigure priority. In a system according to some versions of IEEE 802.11 standards, collision may occur and, in this case, a collision sensing procedure is performed. A transmitting device using CSMA/CA avoids collision between data transmission thereof and data transmission of another transmitting device using a specific rule.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port, a virtual antenna, or an antenna group. A node may be referred to as a point.

In the present invention, a cell refers to a prescribed geographic region to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between an eNB or node which provides a communication service to the specific cell and a UE. In a LTE/LTE-A based system, The UE may measure DL channel state received from a specific node using cell-specific reference signal(s) (CRS(s)) transmitted on a CRS resource allocated by antenna port(s) of the specific node to the specific node and/or channel state information reference signal(s) (CSI-RS(s)) transmitted on a CSI-RS resource. For a detailed CSI-RS configuration, refer to documents such as 3GPP TS 36.211 and 3GPP TS 36.331.

Meanwhile, a 3GPP LTE/LTE-A system uses the concept of a cell to manage a radio resource. A cell associated with the radio resource is different from a cell of a geographic region.

A “cell” of a geographic region may be understood as coverage within which a node can provide a service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, coverage of the node may be associated with coverage of “cell” of a radio resource used by the node. Accordingly, the term “cell” may be used to indicate service coverage by the node sometimes, a radio resource at other times, or a range that a signal using a radio resource can reach with valid strength at other times. The “cell” of the radio resource will be described later in more detail.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS (UE-RS), a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signal.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

Hereinafter, OFDM symbol/subcarrier/RE to or for which CRS/DMRS/CSI-RS/SRS/UE-RS is assigned or configured will be referred to as CRS/DMRS/CSI-RS/SRS/UE-RS symbol/carrier/subcarrier/RE. For example, an OFDM symbol to or for which a tracking RS (TRS) is assigned or configured is referred to as a TRS symbol, a subcarrier to or for which the TRS is assigned or configured is referred to as a TRS subcarrier, and an RE to or for which the TRS is assigned or configured is referred to as a TRS RE. In addition, a subframe configured for transmission of the TRS is referred to as a TRS subframe. Moreover, a subframe in which a broadcast signal is transmitted is referred to as a broadcast subframe or a PBCH subframe and a subframe in which a synchronization signal (e.g. PSS and/or SSS) is transmitted is referred to a synchronization signal subframe or a PSS/SSS subframe. OFDM symbol/subcarrier/RE to or for which PSS/SSS is assigned or configured is referred to as PSS/SSS symbol/subcarrier/RE, respectively.

In the present invention, a CRS port, a UE-RS port, a CSI-RS port, and a TRS port refer to an antenna port configured to transmit a CRS, an antenna port configured to transmit a UE-RS, an antenna port configured to transmit a CSI-RS, and an antenna port configured to transmit a TRS, respectively. Antenna ports configured to transmit CRSs may be distinguished from each other by the locations of REs occupied by the CRSs according to CRS ports, antenna ports configured to transmit UE-RSs may be distinguished from each other by the locations of REs occupied by the UE-RSs according to UE-RS ports, and antenna ports configured to transmit CSI-RSs may be distinguished from each other by the locations of REs occupied by the CSI-RSs according to CSI-RS ports. Therefore, the term CRS/UE-RS/CSI-RS/TRS ports may also be used to indicate a pattern of REs occupied by CRSs/UE-RSs/CSI-RSs/TRSs in a predetermined resource region.

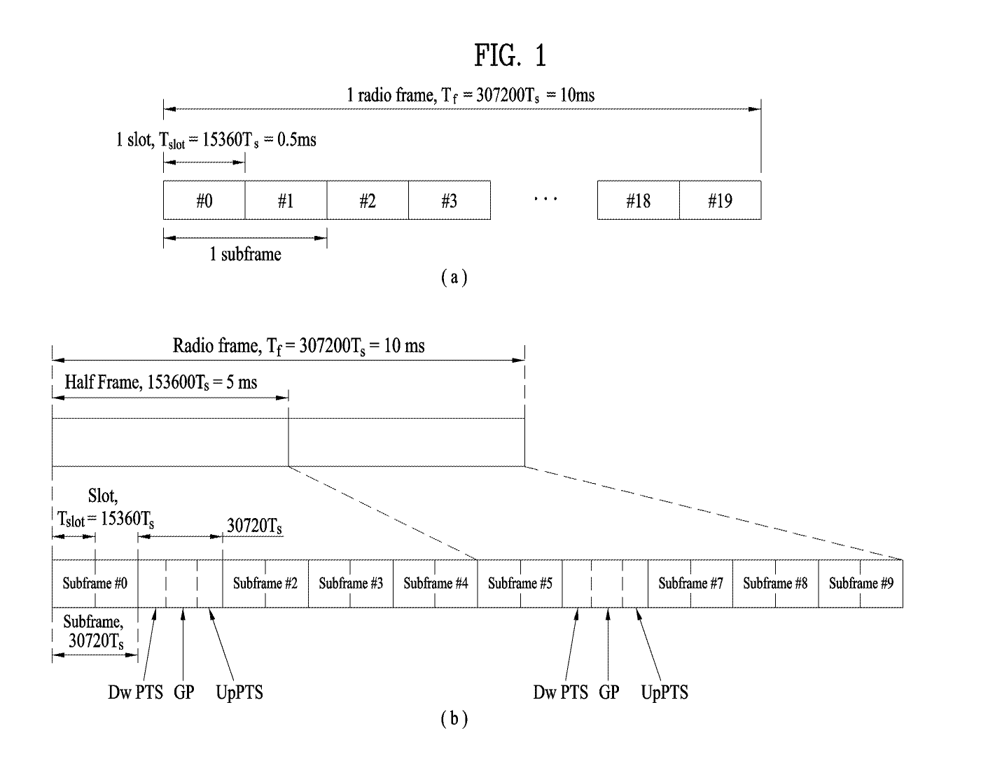

FIG. 1 illustrates the structure of a radio frame used in a wireless communication system.

Specifically, FIG. 1(a) illustrates an exemplary structure of a radio frame which can be used in frequency division multiplexing (FDD) in 3GPP LTE/LTE-A and FIG. 1(b) illustrates an exemplary structure of a radio frame which can be used in time division multiplexing (TDD) in 3GPP LTE/LTE-A. The frame structure of FIG. 1(a) is referred to as frame structure type 1 (FS1) and the frame structure of FIG. 1(b) is referred to as frame structure type 2 (FS2).

Referring to FIG. 1, a 3GPP LTE/LTE-A radio frame is 10 ms (307,200Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| Uplink- | Downlink- | | | | | | | | | | | |
|---|---|---|---|---|---|---|---|---|---|---|---|---|
| downlink | to-Uplink | | | | | | | | | | | |
| configu- | Switch-point | | Subframe number | | | | | | | | | |
| ration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | Normal cyclic prefix in downlink | | | Extended cyclic prefix in down | | |
|---|---|---|---|---|---|---|
| | | UpPTS | | | UpPTS | |
| Special subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | — |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

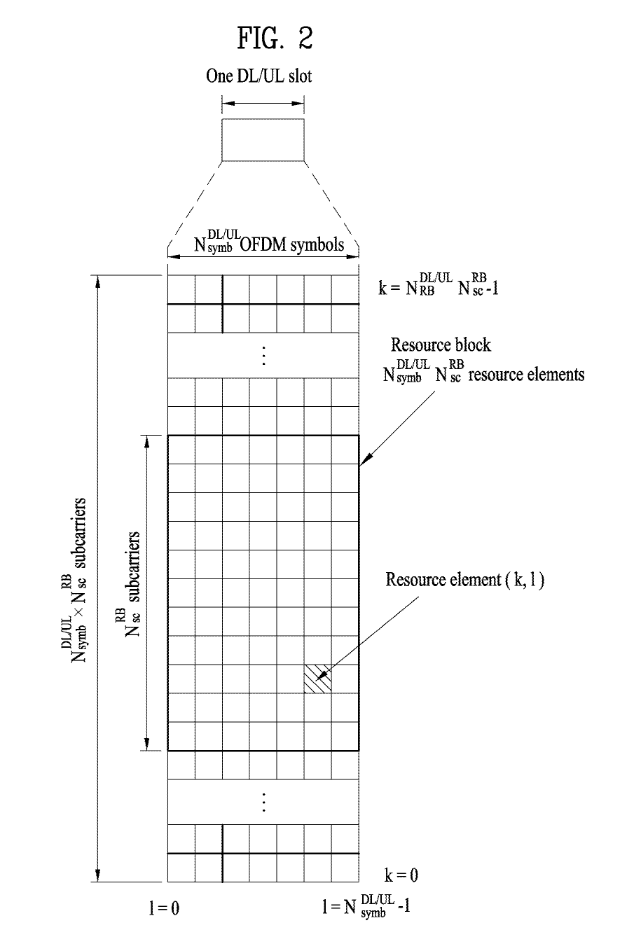

FIG. 2 illustrates the structure of a DL/UL slot structure in a wireless communication system. In particular, FIG. 2 illustrates the structure of a resource grid of a 3GPP LTE/LTE-A system. One resource grid is defined per antenna port.

Referring to FIG. 2, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency f_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k,l) within one slot. k is an index ranging from 0 to N^{DL/UL}_{RB}*N^{RB}_{sc}−1 in the frequency domain, and 1 is an index ranging from 0 to N^{DL/UL}_{symb}1−1 in the time domain.

Meanwhile, one RB is mapped to one physical resource block (PRB) and one virtual resource block (VRB). A PRB is defined as N^{DL}_{symb} (e.g. 7) consecutive OFDM or SC-FDM symbols in the time domain and N^{RB}_{sc} (e.g. 12) consecutive subcarriers in the frequency domain. Accordingly, one PRB is configured with N^{DL/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

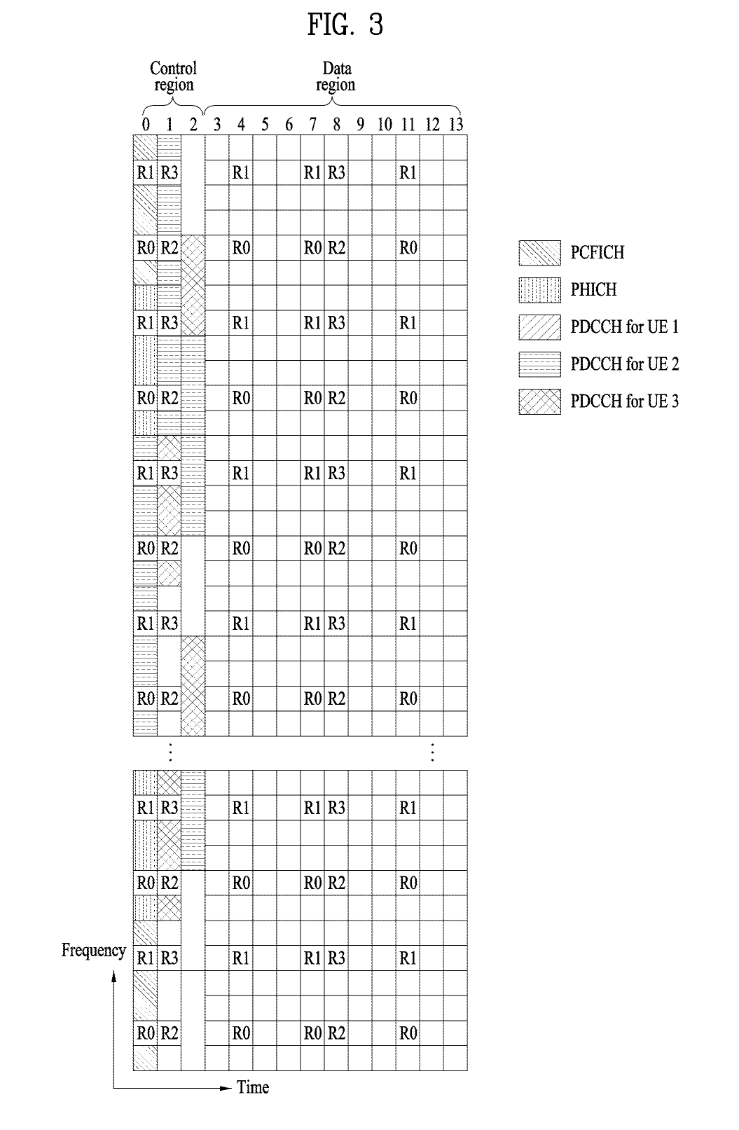

FIG. 3 illustrates the structure of a DL subframe used in a wireless communication system.

Referring to FIG. 3, a DL subframe is divided into a control region and a data region in the time domain. Referring to FIG. 3, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region.

Examples of a DL control channel used in 3GPP LTE include a physical control format indicator channel (PCFICH), a physical downlink control channel (PDCCH), a physical hybrid ARQ indicator channel (PHICH), etc.

The PCFICH is transmitted in the first OFDM symbol of a subframe and carries information about the number of OFDM symbols available for transmission of a control channel within a subframe. The PCFICH notifies the UE of the number of OFDM symbols used for the corresponding subframe every subframe. The PCFICH is located at the first OFDM symbol. The PCFICH is configured by four resource element groups (REGs), each of which is distributed within a control region on the basis of cell ID. One REG includes four REs.

A set of OFDM symbols available for the PDCCH at a subframe is given by the following Table.

TABLE 3

| | Number of OFDM | Number of OFDM |
|---|---|---|
| | symbols for PDCCH | symbols for PDCCH |
| Subframe | when N^{DL}_{RB} >10 | when N^{DL}_{RB} ≤10 |
| Subframe 1 and 6 for frame structure type 2 | 1, 2 | 2 |
| MBSFN subframes on a carrier supporting PDSCH, | 1, 2 | 2 |
| configured with 1 or 2 cell-specific antenna ports | | |
| MBSFN subframes on a carrier supporting PDSCH, | 2 | 2 |
| configured with 4 cell-specific antenna ports | | |
| Subframes on a carrier not supporting PDSCH | 0 | 0 |
| Non-MBSFN subframes (except subframe 6 for frame | 1, 2, 3 | 2, 3 |
| structure type 2) configured with positioning reference | | |
| signals | | |
| All other cases | 1, 2, 3 | 2, 3, 4 |

A subset of downlink subframes within a radio frame on a carrier for supporting PDSCH transmission may be configured as MBSFN subframe(s) by a higher layer. Each MBSFN subframe is divided into a non-MBSFN region and an MBSFN region. The non-MBSFN region spans first one or two OFDM symbols, and its length is given by Table 3. The same CP as cyclic prefix (CP) used for subframe 0 is used for transmission within the non-MBSFN region of the MBSFN subframe. The MBSFN region within the MBSFN subframe is defined as OFDM symbols which are not used in the non-MBSFN region.

The PCFICH carries a control format indicator (CFI), which indicates any one of values of 1 to 3. For a downlink system bandwidth N^{DL}_{RB}>10, the number 1, 2 or 3 of OFDM symbols which are spans of DCI carried by the PDCCH is given by the CFI. For a downlink system bandwidth N^{DL}_{RB}≤10, the number 2, 3 or 4 of OFDM symbols which are spans of DCI carried by the PDCCH is given by CFI+1.

The PHICH carries a HARQ (Hybrid Automatic Repeat Request) ACK/NACK (acknowledgment/negative-acknowledgment) signal as a response to UL transmission. The PHICH includes three REGs, and is scrambled cell-specifically. ACK/NACK is indicated by 1 bit, and the ACK/NACK of 1 bit is repeated three times. Each of the repeated ACK/NACK bits is spread with a spreading factor (SF) 4 or 2 and then mapped into a control region.

The control information transmitted through the PDCCH will be referred to as downlink control information (DCI). The DCI includes resource allocation information for a UE or UE group and other control information. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 2C, 3 and 3A are defined for a DL. Combination selected from control information such as a hopping flag, RB allocation, modulation coding scheme (MCS), redundancy version (RV), new data indicator (NDI), transmit power control (TPC), cyclic shift, cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, a radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at the bit level.

Generally, a DCI format, which may be transmitted to the UE, is varied depending on a transmission mode configured for the UE. In other words, certain DCI format(s) corresponding to the specific transmission mode not all DCI formats may only be used for the UE configured to a specific transmission mode.

For example, a transmission mode is semi-statically configured for the UE by a higher layer so that the UE may receive a PDSCH transmitted in accordance with one of a plurality of transmission modes which are previously defined. The UE attempts to decode a PDCCH using DCI formats only corresponding to its transmission mode. In other words, in order to maintain UE operation load according to blind decoding attempt, at a certain level or less, all DCI formats are not searched by the UE at the same time.

The PDCCH is allocated to first m number of OFDM symbol(s) within a subframe. In this case, m is an integer equal to or greater than 1, and is indicated by the PCFICH.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, one CCE corresponds to nine resource element groups (REGs), and one REG corresponds to four REs. Four QPSK symbols are mapped to each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH).

Assuming that the number of REGs not allocated to the PCFICH or the PHICH is N_{REG}, the number of available CCEs in a DL subframe for PDCCH(s) in a system is numbered from 0 to N_{CCE}−1, where N_{CCE}=floor(N_{REG}/9).

A DCI format and the number of DCI bits are determined in accordance with the number of CCEs. The CCEs are numbered and consecutively used. To simplify the decoding process, a PDCCH having a format including n CCEs may be initiated only on CCEs assigned numbers corresponding to multiples of n. The number of CCEs used for transmission of a specific PDCCH is determined by a network or the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

In a 3GPP LTE/LTE-A system, a set of CCEs on which a PDCCH can be located for each UE is defined. A CCE set in which the UE can detect a PDCCH thereof is referred to as a PDCCH search space or simply as a search space (SS). An individual resource on which the PDCCH can be transmitted in the SS is called a PDCCH candidate. A set of PDCCH candidates that the UE is to monitor is defined as a search space (SS). SSs for respective PDCCH formats may have different sizes and a dedicated SS and a common SS are defined. The dedicated SS is a UE-specific SS (USS) and is configured for each individual UE. The common SS (CSS) is configured for a plurality of UEs.

The following table shows an example of aggregation levels for defining SS.

TABLE 4

| Search space S^{(L)}ₖ | | | Number of |
|---|---|---|---|
| | Aggregation | Size | PDCCH |
| Type | level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) “A” and information about data transmitted using a radio resource “B” (e.g. frequency location) and using transport format information “C” (e.g. transport block size, modulation scheme, coding information, etc.) is transmitted in a specific DL subframe. Then, the UE monitors the PDCCH using RNTI information thereof. The UE having the RNTI “A” receives the PDCCH and receives the PDSCH indicated by “B” and “C” through information of the received PDCCH.

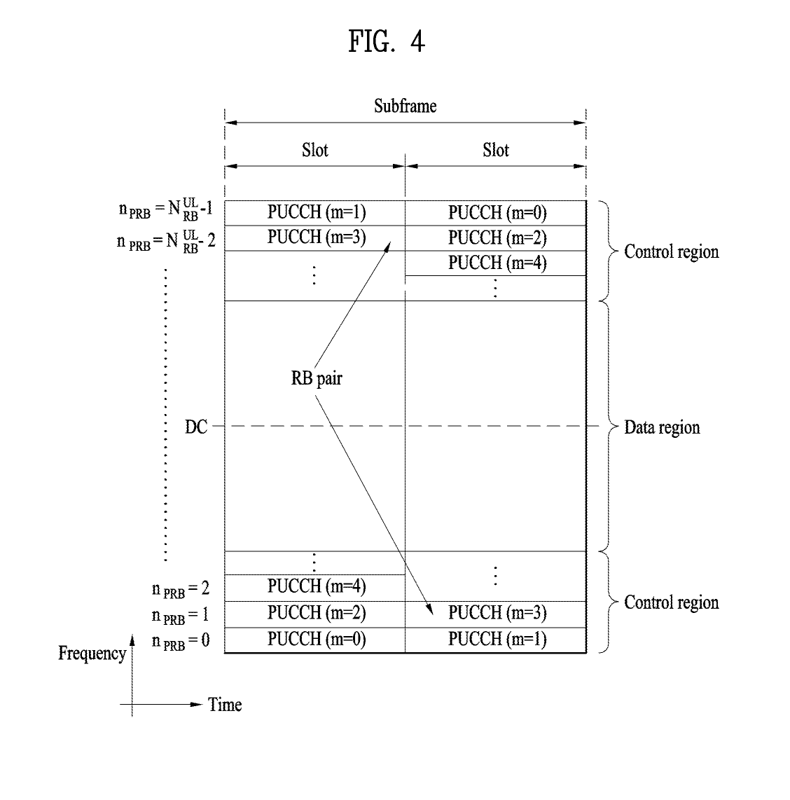

FIG. 4 illustrates the structure of a UL subframe used in a wireless communication system.

Referring to FIG. 4, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. CSI may include channel quality information (CQI), a precoding matrix indicator (PMI), a precoding type indicator, and/or a rank indicator (RI). In the CSI, MIMO-related feedback information includes the RI and the PMI. The RI indicates the number of streams or the number of layers that the UE can receive through the same time-frequency resource. The PMI is a value reflecting a space characteristic of a channel, indicating an index of a preferred precoding matrix for DL signal transmission based on a metric such as an SINR. The CQI is a value of channel strength, indicating a received SINR that can be obtained by the UE generally when the eNB uses the PMI.

A general wireless communication system transmits/receives data through one downlink (DL) band and through one uplink (UL) band corresponding to the DL band (in the case of frequency division duplex (FDD) mode), or divides a prescribed radio frame into a UL time unit and a DL time unit in the time domain and transmits/receives data through the UL/DL time unit (in the case of time division duplex (TDD) mode). Recently, to use a wider frequency band in recent wireless communication systems, introduction of carrier aggregation (or BW aggregation) technology that uses a wider UL/DL BW by aggregating a plurality of UL/DL frequency blocks has been discussed. A carrier aggregation (CA) is different from an orthogonal frequency division multiplexing (OFDM) system in that DL or UL communication is performed using a plurality of carrier frequencies, whereas the OFDM system carries a base frequency band divided into a plurality of orthogonal subcarriers on a single carrier frequency to perform DL or UL communication. Hereinbelow, each of carriers aggregated by carrier aggregation will be referred to as a component carrier (CC).

For example, three 20 MHz CCs in each of UL and DL are aggregated to support a BW of 60 MHz. The CCs may be contiguous or non-contiguous in the frequency domain. Although a case that a BW of UL CC and a BW of DL CC are the same and are symmetrical is described, a BW of each component carrier may be defined independently. In addition, asymmetric carrier aggregation where the number of UL CCs is different from the number of DL CCs may be configured. A DL/UL CC for a specific UE may be referred to as a serving UL/DL CC configured at the specific UE.

In the meantime, the 3GPP LTE-A system uses a concept of cell to manage radio resources. The cell is defined by combination of downlink resources and uplink resources, that is, combination of DL CC and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

The eNB may activate all or some of the serving cells configured in the UE or deactivate some of the serving cells for communication with the UE. The eNB may change the activated/deactivated cell, and may change the number of cells which is/are activated or deactivated. If the eNB allocates available cells to the UE cell-specifically or UE-specifically, at least one of the allocated cells is not deactivated unless cell allocation to the UE is fully reconfigured or unless the UE performs handover. Such a cell which is not deactivated unless CC allocation to the UE is full reconfigured will be referred to as Pcell, and a cell which may be activated/deactivated freely by the eNB will be referred to as Scell. The Pcell and the Scell may be identified from each other on the basis of the control information. For example, specific control information may be set to be transmitted and received through a specific cell only. This specific cell may be referred to as the Pcell, and the other cell(s) may be referred to as Scell(s).

A configured cell refers to a cell in which CA is performed for a UE based on measurement report from another eNB or UE among cells of an eNB and is configured for each UE. The configured cell for the UE may be a serving cell in terms of the UE. The configured cell for the UE, i.e. the serving cell, pre-reserves resources for ACK/NACK transmission for PDSCH transmission. An activated cell refers to a cell configured to be actually used for PDSCH/PUSCH transmission among configured cells for the UE and CSI reporting and SRS transmission for PDSCH/PUSCH transmission are performed on the activated cell. A deactivated cell refers to a cell configured not to be used for PDSCH/PUSCH transmission by the command of an eNB or the operation of a timer and CSI reporting and SRS transmission are stopped on the deactivated cell.

For reference, a carrier indicator (CI) means a serving cell index ServCellIndex and CI=0 is applied to a Pcell. The serving cell index is a short identity used to identify the serving cell and, for example, any one of integers from 0 to ‘maximum number of carrier frequencies which can be configured for the UE at a time minus 1’ may be allocated to one serving cell as the serving cell index. That is, the serving cell index may be a logical index used to identify a specific serving cell among cells allocated to the UE rather than a physical index used to identify a specific carrier frequency among all carrier frequencies.

As described above, the term “cell” used in carrier aggregation is differentiated from the term “cell” indicating a certain geographical area where a communication service is provided by one eNB or one antenna group.

The cell mentioned in the present invention means a cell of carrier aggregation which is combination of UL CC and DL CC unless specifically noted.

Meanwhile, since one serving cell is only present in case of communication based on a single carrier, a PDCCH carrying UL/DL grant and corresponding PUSCH/PDSCH are transmitted on one cell. In other words, in case of FDD under a single carrier environment, a PDCCH for a DL grant for a PDSCH, which will be transmitted on a specific DL CC, is transmitted on the specific CC, and a PDCCH for a UL grant for a PUSCH, which will be transmitted on a specific UL CC, is transmitted on a DL CC linked to the specific UL CC. In case of TDD under a single carrier environment, a PDCCH for a DL grant for a PDSCH, which will be transmitted on a specific DL CC, is transmitted on the specific CC, and a PDCCH for a UL grant for a PUSCH, which will be transmitted on a specific UL CC, is transmitted on the specific CC.

On the contrary, since a plurality of serving cells may be configured in a multi-carrier system, transmission of UL/DL grant through a serving cell having a good channel status may be allowed. In this way, if a cell carrying UL/DL grant which is scheduling information is different from a cell where UL/DL transmission corresponding to the UL/DL grant is performed, this will be referred to as cross-carrier scheduling.

Hereinafter, the case where the cell is scheduled from itself and the case where the cell is scheduled from another cell will be referred to as self-CC scheduling and cross-CC scheduling, respectively.

For data transmission rate enhancement and stable control signaling, the 3GPP LTE/LTE-A may support aggregation of a plurality of CCs and a cross carrier-scheduling operation based on the aggregation.

If cross-carrier scheduling (or cross-CC scheduling) is applied, a PDCCH for downlink allocation for a DL CC B or DL CC C, that is, carrying a DL grant may be transmitted through a DL CC A, and a corresponding PDSCH may be transmitted through the DL CC B or DL CC C. For cross-CC scheduling, a carrier indicator field (CIF) may be introduced. The presence or absence of the CIF within the PDCCH may be semi-statically and UE-specifically (or UE-group-specifically) configured by higher layer signaling (e.g., RRC signaling).

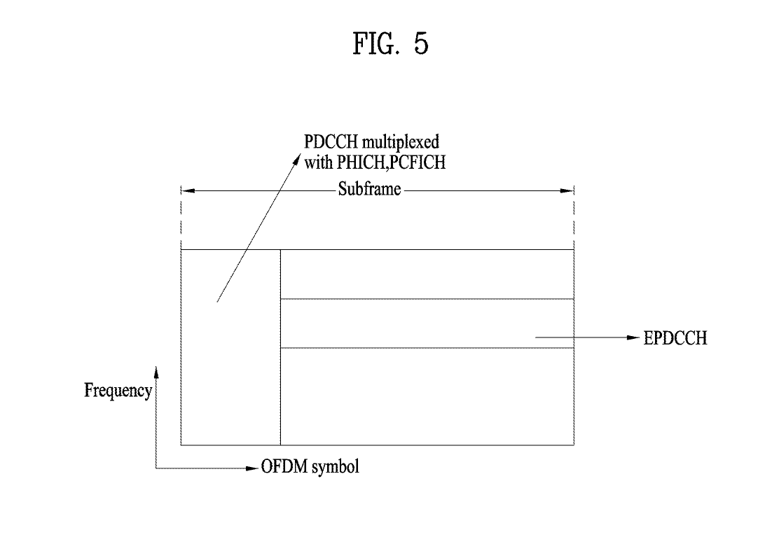

FIG. 5 is an example of a downlink control channel configured in a data region of a DL subframe.

Meanwhile, if RRH technology, cross-carrier scheduling technology, etc. are introduced, the amount of PDCCH which should be transmitted by the eNB is gradually increased. However, since a size of a control region within which the PDCCH may be transmitted is the same as before, PDCCH transmission acts as a bottleneck of system throughput. Although channel quality may be improved by the introduction of the aforementioned multi-node system, application of various communication schemes, etc., the introduction of a new control channel is required to apply the legacy communication scheme and the carrier aggregation technology to a multi-node environment. Due to the need, a configuration of a new control channel in a data region (hereinafter, referred to as PDSCH region) not the legacy control region (hereinafter, referred to as PDCCH region) has been discussed. Hereinafter, the new control channel will be referred to as an enhanced PDCCH (hereinafter, referred to as EPDCCH).

The EPDCCH may be configured within rear OFDM symbols starting from a configured OFDM symbol, instead of front OFDM symbols of a subframe. The EPDCCH may be configured using continuous frequency resources, or may be configured using discontinuous frequency resources for frequency diversity. By using the EPDCCH, control information per node may be transmitted to a UE, and a problem that a legacy PDCCH region may not be sufficient may be solved. For reference, the PDCCH may be transmitted through the same antenna port(s) as that(those) configured for transmission of a CRS, and a UE configured to decode the PDCCH may demodulate or decode the PDCCH by using the CRS. Unlike the PDCCH transmitted based on the CRS, the EPDCCH is transmitted based on the demodulation RS (hereinafter, DMRS). Accordingly, the UE decodes/demodulates the PDCCH based on the CRS and decodes/demodulates the EPDCCH based on the DMRS. The DMRS associated with EPDCCH is transmitted on the same antenna port p∈{107,108,109,110} as the associated EPDCCH physical resource, is present for EPDCCH demodulation only if the EPDCCH transmission is associated with the corresponding antenna port, and is transmitted only on the PRB(s) upon which the corresponding EPDCCH is mapped. For example, the REs occupied by the UE-RS(s) of the antenna port 7 or 8 may be occupied by the DMRS(s) of the antenna port 107 or 108 on the PRB to which the EPDCCH is mapped, and the REs occupied by the UE-RS(s) of antenna port 9 or 10 may be occupied by the DMRS(s) of the antenna port 109 or 110 on the PRB to which the EPDCCH is mapped. In other words, a certain number of REs are used on each RB pair for transmission of the DMRS for demodulation of the EPDCCH regardless of the UE or cell if the type of EPDCCH and the number of layers are the same as in the case of the UE-RS for demodulation of the PDSCH.

For each serving cell, higher layer signaling can configure a UE with one or two EPDCCH-PRB-sets for EPDCCH monitoring. The PRB-pairs corresponding to an EPDCCH-PRB-set are indicated by higher layers. Each EPDCCH-PRB-set consists of set of ECCEs numbered from 0 to N_{ECCE,p,k}−1, where N_{ECCE,p,k} is the number of ECCEs in EPDCCH-PRB-set p of subframe k. Each EPDCCH-PRB-set can be configured for either localized EPDCCH transmission or distributed EPDCCH transmission.

The UE shall monitor a set of EPDCCH candidates on one or more activated serving cells as configured by higher layer signaling for control information.

The set of EPDCCH candidates to monitor are defined in terms of EPDCCH UE-specific search spaces. For each serving cell, the subframes in which the UE monitors EPDCCH UE-specific search spaces are configured by higher layers.

An EPDCCH UE-specific search space ES^{(L)}ₖ at aggregation level L∈{1,2,4,8,16,32} is defined by a set of EPDCCH candidates. For an EPDCCH-PRB-set p configured for distributed transmission, the ECCEs corresponding to EPDCCH candidate m of the search space ES^{(L)}ₖ are given by the following table.

Equation 1

$$L \{ ( {Y}_{p , k} + ⌊ \frac{m \cdot {N}_{ECCE , p , k}}{L \cdot {M}_{p}^{( L )}} ⌋ + b ) mod ⌊ {N}_{ECCE , p , k} \text{/} L ⌋ \} + i$$

where i=0, . . . ,L−1. b=n_{CI} if the UE is configured with a carrier indicator field for the serving cell on which EPDCCH is monitored, otherwise b=0. n_{CI} is the carrier indicator field (CIF) value, which is the same as a serving cell index (ServCellIndex). m=0,1, . . . , M^{(L)}ₚ−1, M^{(L)}ₚ is the number of EPDCCH candidates to monitor at aggregation level L in EPDCCH-PRB-set p. The variable Y_{p,k} is defined by ‘Y_{p,k}=(Aₚ·Y_{p,k-1}) mod D’, where Y_{p,k-1}=n_{RNTI}≠0, A₀=39827, A₀=39829, D=65537 and k=floor(nₛ/2). nₛ is the slot number within a radio frame.

A UE is not expected to monitor an EPDCCH candidate, if an ECCE corresponding to that EPDCCH candidate is mapped to a PRB pair that overlaps in frequency with a transmission of either PBCH or PSS/SSS in the same subframe.

An EPDCCH is transmitted using an aggregation of one or several consecutive enhanced control channel elements (ECCEs). Each ECCE consists of multiple enhanced resource element groups (EREGs). EREGs are used for defining the mapping of enhanced control channels to resource elements. There are 16 EREGs, numbered from 0 to 15, per physical resource block (PRB) pair. Number all resource elements (REs), except resource elements carrying DMRS (hereinafter, EPDCCH DMRS) for demodulation of the EPDCCH, in a physical resource-block pair cyclically from 0 to 15 in an increasing order of first frequency. Therefore, all the REs, except REs carrying the EPDCCH DMRS, in the PRB pair has any one of numbers 0 to 15. All REs with number i in that PRB pair constitutes EREG number i. As described above, it is noted that EREGs are distributed on frequency and time axes within the PRB pair and an EPDCCH transmitted using aggregation of one or more ECCEs, each of which includes a plurality of EREGs, is also distributed on frequency and time axes within the PRB pair.

The number of ECCEs used for one EPDCCH depends on the EPDCCH format as given by Table 5, the number of EREGs per ECCE is given by Table 6. Table 5 shows an example of supported EPDCCH formats, and Table 6 shows an example of the number of EREGs per ECCE, N^{EREG}_{ECCE}. Both localized and distributed transmission is supported.

TABLE 5

| | Number of ECCEs for one EPDCCH, N^{ECCE}_{EPDCCH} | | | |
|---|---|---|---|---|
| | Case A | | Case B | |
| EPDCCH | Localized | Distributed | Localized | Distributed |
| format | transmission | transmission | transmission | transmission |
| 0 | 2 | 2 | 1 | 1 |
| 1 | 4 | 4 | 2 | 2 |
| 2 | 8 | 8 | 4 | 4 |
| 3 | 16 | 16 | 8 | 8 |
| 4 | — | 32 | — | 16 |

TABLE 6

| Normal cyclic prefix | | | Extended cyclic prefix | |
|---|---|---|---|---|
| | Special | | | Special |
| | subframe, | Special subframe, | | subframe, |
| Normal | configuration | configuration | Normal | configuration |
| subframe | 3, 4, 8 | 1, 2, 6, 7, 9 | subframe | 1, 2, 3, 5, 6 |

| | |
|---|---|
| 4 | 8 |

An EPDCCH can use either localized or distributed transmission, differing in the mapping of ECCEs to EREGs and PRB pairs. One or two sets of PRB pairs which a UE shall monitor for EPDCCH transmissions can be configured. All EPDCCH candidates in EPDCCH set Sₚ (i.e., EPDCCH-PRB-set) use either only localized or only distributed transmission as configured by higher layers. Within EPDCCH set Sₚ in subframe k, the ECCEs available for transmission of EPDCCHs are numbered from 0 to N_{ECCE,p,k}−1. ECCE number n is corresponding to the following EREG(s):
EREGs numbered (n modN^{ECCE}_{RB})+jN^{ECCE}_{RB} in PRB index floor(n/N^{ECCE}_{RB}) for localized mapping, and
EREGs numbered floor (n/N^{Sm}_{RB})+jN^{ECCE}_{RB} in PRB indices (n+jmax(1,N^{Sp}_{RB}/N^{EREG}_{ECCE}))modN^{Sp}_{RB} for distributed mapping,

where j=0,1, . . . ,N^{EREG}_{ECCE}−1, N^{EREG}_{ECCE} is the number of EREGs per ECCE, and N^{ECCE}_{RB}=16/N^{EREG}_{ECCE} is the number of ECCEs per RB pair. The PRB pairs constituting EPDCCH set Sₚ are assumed to be numbered in ascending order from 0 to N^{Sp}_{RB}−1.

Case A in Table 5 applies when:
DCI formats 2, 2A, 2B, 2C or 2D is used and N^{DL}_{RB}≥25, or
any DCI format when n_{EPDCCH}<104 and normal cyclic prefix is used in normal subframes or special subframes with configuration 3, 4, 8.

Otherwise case 2 is used. The quantity n_{EPDCCH} for a particular UE is defined as the number of downlink resource elements (k,l) in a PRB pair configured for possible EPDCCH transmission of EPDCCH set S₀ and and fulfilling all of the following criteria,
they are part of any one of the 16 EREGs in the physical resource-block pair,
they are assumed by the UE not to be used for CRSs or CSI-RSs,
the index/in a subframe fulfils l≥l_{EPDCCHStart}.

where l_{EPDCCHStart} is given based on higher layer signaling ‘epdcch-StartSymbol-r11’, higher layer signaling ‘pdsch-Start-r11’, or CFI value carried by PCFICH.

The mapping to resource elements (k,l) on antenna port p meeting the criteria above is in increasing order of first the index k and then the index l, starting with the first slot and ending with the second slot in a subframe.

For localized transmission, the single antenna port p to use is given by Table 10 with n′=n_{ECCE,low} mod N^{ECCE}_{RB}+n_{RNTI} mod min(N^{ECCE}_{EPDCCH},N^{ECCE}_{RB}), where n_{ECCE,low} is the lowest ECCE index used by this EPDCCH transmission in the EPDCCH set, n_{RNTI} corresponds to the RNTI associated with the EPDCCH transmission, and N^{ECCE}_{EPDCCH} is the number of ECCEs used for this EPDCCH.

TABLE 7

| | Normal cyclic prefix | | |
|---|---|---|---|
| | Normal subframes, | | |
| | Special subframes, | Special subframes, | Extended cyclic |
| | configurations | configurations | prefix |
| n′ | 3, 4, 8 | 1, 2, 6, 7, 9 | Any subframe |
| 0 | 107 | 107 | 107 |
| 1 | 108 | 109 | 108 |
| 2 | 109 | — | — |
| 3 | 110 | — | — |

For distributed transmission, each resource element in an EREG is associated with one out of two antenna ports in an alternating manner where p∈{107,109} for normal cyclic prefix and p∈{107,108} for extended cyclic prefix.

Hereinafter, a PDCCH and an EPDCCH are collectively referred to as PDCCHs or (E)PDCCHs.

Recently, machine type communication (MTC) has come to the fore as a significant communication standard issue. MTC refers to exchange of information between a machine and an eNB without involving persons or with minimal human intervention. For example, MTC may be used for data communication for measurement/sensing/reporting such as meter reading, water level measurement, use of a surveillance camera, inventory reporting of a vending machine, etc. and may also be used for automatic application or firmware update processes for a plurality of UEs. In MTC, the amount of transmission data is small and UL/DL data transmission or reception (hereinafter, transmission/reception) occurs occasionally. In consideration of such properties of MTC, it would be better in terms of efficiency to reduce production cost and battery consumption of UEs for MTC (hereinafter, MTC UEs) according to data transmission rate. Since the MTC UE has low mobility, the channel environment thereof remains substantially the same. If an MTC UE is used for metering, reading of a meter, surveillance, and the like, the MTC UE is very likely to be located in a place such as a basement, a warehouse, and mountain regions which the coverage of a typical eNB does not reach. In consideration of the purposes of the MTC UE, it is better for a signal for the MTC UE to have wider coverage than the signal for the conventional UE (hereinafter, a legacy UE).

When considering the usage of the MTC UE, there is a high probability that the MTC UE requires a signal of wide coverage compared with the legacy UE. Therefore, if the eNB transmits a PDCCH, a PDSCH, etc. to the MTC UE using the same scheme as a scheme of transmitting the PDCCH, the PDSCH, etc. to the legacy UE, the MTC UE has difficulty in receiving the PDCCH, the PDSCH, etc. Therefore, the present invention proposes that the eNB apply a coverage enhancement scheme such as subframe repetition (repetition of a subframe with a signal) or subframe bundling upon transmission of a signal to the MTC UE having a coverage issue so that the MTC UE can effectively receive a signal transmitted by the eNB. For example, the PDCCH and/or PDSCH may be transmitted to the MTC UE having a coverage issue through multiple (e.g., about 100) subframes.

Embodiments of the present invention described below may be applied to a new radio access technology (RAT) system in addition to the 3GPP LTE/LTE-A system. As more and more communication devices demand larger communication capacity, there is a need for improved mobile broadband communication compared to existing RAT. Also, massive MTC, which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC, and URLLC (Ultra-Reliable and Low Latency Communication), is being discussed. In the present invention, this technology is referred to as new RAT for simplicity.

In the next system of LTE-A, a method to reduce latency of data transmission is considered. Packet data latency is one of the performance metrics that vendors, operators and also end-users (via speed test applications) regularly measure. Latency measurements are done in all phases of a radio access network system lifetime, when verifying a new software release or system component, when deploying a system and when the system is in commercial operation.

Better latency than previous generations of 3GPP RATs was one performance metric that guided the design of LTE. LTE is also now recognized by the end-users to be a system that provides faster access to internet and lower data latencies than previous generations of mobile radio technologies.

However, with respect to further improvements specifically targeting the delays in the system little has been done. Packet data latency is important not only for the perceived responsiveness of the system; it is also a parameter that indirectly influences the throughput. HTTP/TCP is the dominating application and transport layer protocol suite used on the internet today. According to HTTP Archive (http://httparchive.org/trends.php) the typical size of HTTP-based transactions over the internet are in the range from a few 10's of Kbytes up to 1 Mbyte. In this size range, the TCP slow start period is a significant part of the total transport period of the packet stream. During TCP slow start the performance is latency limited. Hence, improved latency can rather easily be shown to improve the average throughput, for this type of TCP-based data transactions. In addition, to achieve really high bit rates (in the range of Gbps), UE L2 buffers need to be dimensioned correspondingly. The longer the round trip time (RTT) is, the bigger the buffers need to be. The only way to reduce buffering requirements in the UE and eNB side is to reduce latency.

Radio resource efficiency could also be positively impacted by latency reductions. Lower packet data latency could increase the number of transmission attempts possible within a certain delay bound; hence higher block error ration (BLER) targets could be used for the data transmissions, freeing up radio resources but still keeping the same level of robustness for users in poor radio conditions. The increased number of possible transmissions within a certain delay bound, could also translate into more robust transmissions of real-time data streams (e.g. VoLTE), if keeping the same BLER target. This would improve the VoLTE voice system capacity.

There are more over a number of existing applications that would be positively impacted by reduced latency in terms of increased perceived quality of experience: examples are gaming, real-time applications like VoLTE/OTT VoIP and video telephony/conferencing.

Going into the future, there will be a number of new applications that will be more and more delay critical. Examples include remote control/driving of vehicles, augmented reality applications in e.g. smart glasses, or specific machine communications requiring low latency as well as critical communications.

In embodiments of the present invention, which will be described below, “assumes” may mean that an entity transmitting a channel transmits the channel in accordance with the corresponding “assumption” or that an entity receiving the channel receives or decodes the channel in the form conforming to the “assumption” on the premise that the channel has been transmitted according to the “assumption”.

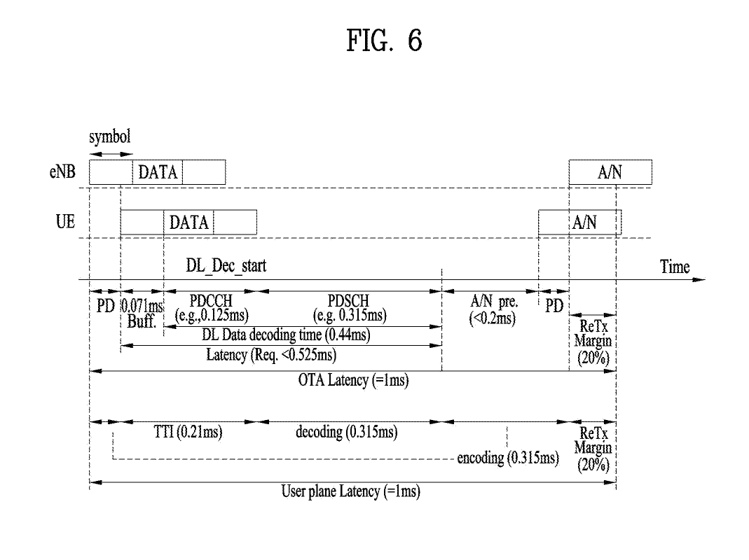

FIG. 6 illustrates the length of a transmission time interval (TTI) which is needed to implement low latency.

Referring to FIG. 6, a propagation delay (PD), a buffering time, a decoding time, an A/N preparation time, an uplink PD, and an OTA (over the air) delay according to a retransmission margin are produced while a signal transmitted from the eNB reaches the UE, the UE transmits an A/N for the signal, and the A/N reaches the eNB. To satisfy low latency, a shortened TTI (sTTI) shorter than or equal to 0.5 ms needs to be designed by shortening the TTI, which is the smallest unit of data transmission. For example, to shorten the OTA delay, which is a time taken from the moment the eNB starts to transmit data (PDCCH and PDSCH) until the UE completes transmission of an A/N for the data to the eNB, to a time shorter than 1 ms, the TTI is preferably set to 0.21 ms. That is, to shorten the user plane (U-plane) delay to 1 ms, the sTTI may be set in the unit of about three OFDM symbols.

While FIG. 6 illustrates that the sTTI is configured with three OFDM symbols to satisfy 1 ms as the OTA delay or U-plane delay, an sTTI shorter than 1 ms may also be configured. For example, for the normal CP, an sTTI consisting of 2 OFDM symbols, an sTTI consisting of 4 OFDM symbols and/or an sTTI consisting of 7 OFDM symbols may be configured.

In the time domain, all OFDM symbols constituting a default TTI or the OFDM symbols except the OFDM symbols occupying the PDCCH region of the TTI may be divided into two or more sTTIs on some or all frequency resources in the frequency band of the default TTI, namely the channel band or system band of the TTI.

In the following description, a default TTI or main TTI used in the system is referred to as a TTI or subframe, and the TTI having a shorter length than the default/main TTI of the system is referred to as an sTTI. For example, in a system in which a TTI of 1 ms is used as the default TTI as in the current LTE/LTE-A system, a TTI shorter than 1 ms may be referred to as the sTTI. In addition, in the following description, a physical downlink control channel/physical downlink data channel/physical uplink control channel/physical uplink data channel transmitted in units of the default/main TTI are referred to as a PDCCH/PDSCH/PUCCH/PUSCH, and a PDCCH/PDSCH/PUCCH/PUSCH transmitted within an sTTI or in units of sTTI are referred to as sPDCCH/sPDSCH/sPUCCH/sPUSCH. In the new RAT environment, the numerology may be changed, and thus a default/main TTI different from that for the current LTE/LTE-A system may be used. However, for simplicity, the default/main TTI will be referred to as a TTI, subframe, legacy TTI or legacy subframe, and a TTI shorter than 1 ms will be referred to as an sTTI, on the assumption that the time length of the default/main TTI is 1 ms. The method of transmitting/receiving a signal in a TTI and an sTTI according to embodiments described below is applicable not only to the system according to the current LTE/LTE-A numerology but also to the default/main TTI and sTTI of the system according to the numerology for the new RAT environment.

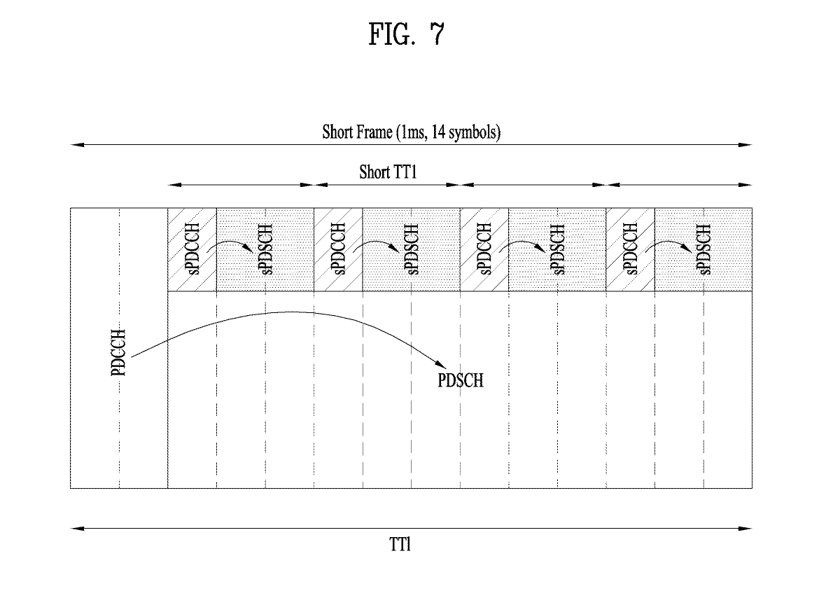

FIG. 7 illustrates an sTTI and transmission of a control channel and data channel within the sTTI.

In the downlink environment, a PDCCH for transmission/scheduling of data within an sTTI (i.e., sPDCCH) and a PDSCH transmitted within an sTTI (i.e., sPDSCH) may be transmitted. For example, referring to FIG. 7, a plurality of the sTTIs may be configured within one subframe, using different OFDM symbols. For example, the OFDM symbols in the subframe may be divided into one or more sTTIs in the time domain. OFDM symbols constituting an sTTI may be configured, excluding the leading OFDM symbols on which the legacy control channel is transmitted. Transmission of the sPDCCH and sPDSCH may be performed in a TDM manner within the sTTI, using different OFDM symbol regions. In an sTTI, the sPDCCH and sPDSCH may be transmitted in an FDM manner, using different regions of PRB(s)/frequency resources.

When transmission of a legacy PDSCH is considered, the sPDCCH and the sPDSCH are preferably transmitted only in partial PRB regions of the entire system bandwidth. Hereinafter, a method of determining a PRB location in which the sPDCCH and the sPDSCH are configured will be proposed.

A frequency resource on which the sPDCCH and/or the sPDSCH (hereinafter, sPDCCH/sPDSCH) is transmitted may be configured by consecutive or non-consecutive PRBs. Hereinafter, a method of configuring PRB(s) in which the sPDCCH is transmitted (or PRB(s) constituting a search space of the sPDCCH) and a method of allocating a PRB in which the sPDSCH is transmitted will be proposed.

When data is transmitted/received using an sTTI, two-level DCI may be considered as a scheme of smoothly transmitting the sPDCCH within the sTTI by reducing the size of DCI. Transmission of the 2-level DCI indicates that information for scheduling data is separately transmitted in two DCIs or information necessary to receive the sPDCCH and the sPDSCH/sPUSCH is separately transmitted in two DCIs. Hereinafter, such two DCIs are referred to as first DCI (or slow DCI) and second DCI (or fast DCI). The two DCIs may be transmitted through different PDCCHs or sPDCCHs (hereinafter, (s)PDCCH) or different control channels. In this case, the first DCI may provide invariant information in at least one subframe. The first DCI may be transmitted through the sPDCCH/PDCCH or a legacy PDCCH in, for example, an OFDM symbol region for the legacy PDCCH. The second DCI may be transmitted through the sPDCCH within each sTTI. The second DCI may contain dynamic configuration information related to data transmission scheduled by the sPDCCH. The first DCI is carried in a legacy PDCCH region and is transmitted at most once per subframe. The second DCI is carried through the sPDCCH and is transmitted within one sTTI. For example, the first DCI may configure a transmission resource of the sPDSCH/sPUSCH in a corresponding subframe and the second DCI may configure scheduling/non-scheduling of the sPDSCH/sPUSCH, a detailed MCS value, and the like. If the first DCI is transmitted, a configuration by the first DCI may be applied only in a subframe in which the first DCI is transmitted. Alternatively, it may be determined that the configuration is kept valid before the next configuration is transmitted.

A. sPDCCH PRB Location Configuration

One or multiple PRB-sets may be present for transmission of the sPDCCH. One sPDCCH may be transmitted using resource(s) in one PRB-set among the one or multiple PRB-sets. For example, when multiple decoding candidates in which the sPDCCH can be transmitted in a UE-specific search space are present, each decoding candidate may be configured by resources in the same PRB-set.

PRB resources on which the UE performs monitoring to receive the sPDCCH, i.e., PRB(s) constituting each PRB-set, may be determined as follows.

Method 1. Fixed Location

The locations of PRB(s) constituting each PRB-set may be fixed and defined (in the standard specification). The PRB location may be cell-specifically determined. For example, in order to reduce inter-cell interference, PRB(s) constituting each-PRB set may be determined according to cell ID. The PRB location may be differently configured per PRB-set. For example, different PRB(s) per PRB-set may be used according to a PRB set ID. The PRB location may vary with a parameter indicating a time value such as a subframe index, a slot index, and/or an sTTI index, for the purpose of randomization according to time.

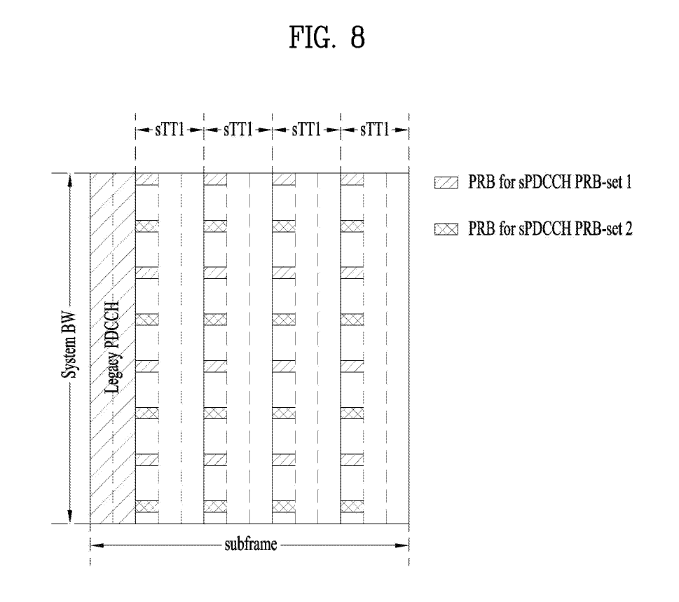

FIG. 8 illustrates an example of resource allocation for a control channel within an sTTI.

To maximally obtain a frequency diversity effect during transmission of an sPDCCH, PRBs constituting a PRB-set may be evenly distributed within a system bandwidth. For example, referring to FIG. 8, PRBs constituting each PRB-set may be distributively located within a system bandwidth. PRB regions constituting different PRB-sets may be alternately present in the frequency domain.

If a legacy PDSCH is being transmitted in a subframe and a PRB resource used to transmit the PDSCH in the above subframe overlaps a PRB resource which is to be used to transmit the sPDCCH, problems may occur in transmitting the sPDCCH. However, if multiple PRB-sets are configured, since the sPDCCH may be transmitted using a PRB-set consisting of PRBs in which the PDSCH is not transmitted, an eNB may flexibly transmit the sPDCCH.

Method 2. RRC Configuration

A PRB location constituting each PRB-set may be semi-statically configured through an RRC signal. For a configuration of each PRB-set transmitted through the RRC signal, a PRB-set index, the number of PRBs, a PRB location, locations/number of OFDM symbols constituting an sPDCCH search space in the corresponding PRB-set (or locations/number of OFDM symbol resources of an sPDCCH transmitted in the PRB-set) may also be configured.

The RRC signal including the configuration for the PRB-set may be transmitted through the sPDCCH. Alternatively, the configuration for the PRB-set may be transmitted through a PDCCH common search space (CSS) and/or a UE-specific search space (USS).

Method 3. DCI Configuration

A PRB location constituting each PRB-set may be more dynamically configured through a DCI configuration. A UE may be notified of configurations for each PRB-set through DCI. For example, information about a PRB-set index, the number of PRBs, a PRB location, the locations/number of OFDM symbols constituting an sPDCCH search space in the corresponding PRB-set, or the locations/number of OFDM symbol resources of the sPDCCH transmitted in the corresponding PRB-set may be provided to the UE as PRB-set configuration information. Alternatively, the entire configuration for the PRB-set may be configured through RRC and information only about the number of PRBs and/or the PRB location may be dynamically configured through the DCI.

A dynamic configuration of a PRB location through the DCI may advantageously increase flexibility of transmission of the sPDCCH by the eNB, (when one PRB-set or a small number of PRB sets are present) when a resource of a legacy PDSCH overlaps the PRB resource of the PRB-set, or by changing a PRB resource location of the PRB-set.

DCI carrying information about a PRB location constituting each PRB-set and/or additional PRB-set configuration(s) may be transmitted as follows.

Option 1. Transmission Through sPDCCH

DCI for configuring a PRB location constituting each PRB-set and/or configuring additional PRB-set(s) may be transmitted through the sPDCCH. In this case, a time point at which a DCI configuration carried by the sPDCCH is applied may be as follows.
Option 1-a) sPDCCH related configuration information configured by the DCI may be applied only to the next sTTI of an sTTI in which the DCI is transmitted through the sPDCCH.
Option 1-b) The sPDCCH related configuration information configured by the DCI may be applied until the UE receives and applies a new configuration from the next sTTI of an sTTI in which the DCI is transmitted through the sPDCCH or during a specific duration.
Option 1-c) The sPDCCH related configuration information configured by the DCI may be applied only in the next subframe of a subframe in which the DCI is transmitted through the sPDCCH.
Option 1-d) The sPDCCH related configuration information configured by the DCI may be applied until the UE receives and applies a new configuration from the next subframe of a subframe in which the DCI is transmitted through the sPDCCH or during a specific duration.

Option 2. Transmission Through PDCCH USS/CSS

DCI for configuring a PRB location constituting each PRB-set and/or configuring additional PRB-set(s) may be transmitted through a CSS and/or a USS of a legacy PDCCH. Herein, a time point at which a DCI configuration carried by the PDCCH is applied may be as follows.
Option 2-a) The sPDCCH related configuration information configured by the DCI may be applied only to all sTTIs of a subframe in which the DCI is transmitted through the PDCCH.
Option 2-b) The sPDCCH related configuration information configured by the DCI may be applied until the UE receives and applies a new configuration from a subframe in which the DCI is transmitted through the PDCCH or during a specific duration.
Option 2-c) The sPDCCH related configuration information configured by the DCI may be applied until the last sTTI from an k-th (e.g., second) sTTI within a subframe in which the DCI is transmitted through the PDCCH.
Option 2-d) The sPDCCH related configuration information configured by the DCI may be applied until the UE receives and applies a new configuration from a k-th (e.g., second) sTTI in a subframe in which the DCI is transmitted through the PDCCH or during a specific duration.
Option 2-e) The sPDCCH related configuration information configured by the DCI may be applied only to all sTTIs of the next subframe of a subframe in which the DCI is transmitted through the PDCCH.
Option 2-f) The sPDCCH related configuration information configured by the DCI may be applied until the UE receives and applies a new configuration from the next subframe of a subframe in which the DCI is transmitted through the PDCCH or during a specific duration.

Option 3. Transmission Through Fast DCI (i.e., Second DCI)

In an environment in which control information can be transmitted to the UE using 2-level DCI, PRB resource information of an sPDCCH through which the UE is to perform monitoring may be transmitted through first DCI (i.e., slow DCI).

For reference, Option 2-a to Option 2-f in Option 2 include transmission of fast DCI through a PDCCH USS/CSS of Option 3. When the fast DCI of Option 3 is transmitted according to any one of Option 2-a to Option 2-f, the ‘DCI transmitted through the PDCCH’ in Option 2-a to Option 2-f is replaced with ‘fast DCI’ or ‘fast DCI transmitted through the PDCCH’.

Method 4. UE Blind Detection

The UE is able to discover a PRB location constituting each PRB-set through blind detection. For example, multiple candidates of PRB combinations which can constitute the PRB-set may be present and the UE may receive the sPDCCH by attempting to receive the sPDCCH with respect to all candidates. Method 4 may be proper when there is a small number of PRB-sets (e.g., one PRB-set).

For example, if candidate 1 of PRB combinations constituting a specific PRB-set includes PRB #0, PRB #6, PRB #12, and PRB #18 and candidate 2 of PRB combinations includes PRB #3, PRB #9, PRB #15, and PRB #21, the UE may attempt to receive the sPDCCH under the assumption that the sPDCCH is transmitted by PRB combinations of candidate 1 and attempt to receive the sPDCCH under the assumption that the sPDCCH is transmitted by PRB combinations of candidate 2. In other words, the UE may attempt to receive the sPDCCH within PRB(s) of candidate 1 under the assumption that an sPDCCH search space is configured by the PRB combinations of candidate 1 and attempt to receive the sPDCCH within PRB(s) of candidate 2 under the assumption that the sPDCCH search space is configured by the PRB combinations of candidate 2.

The eNB may transmit the sPDCCH using only one candidate among candidates of PRB combinations constituting the PRB-set. In other words, the eNB may configure the sPDCCH search space with one of the candidates of the PRB combinations. When multiple DCIs are transmitted to the UE within one sTTI or within one sPDCCH search space, all of the DCIs may be transmitted using the same PRB combination candidate.

Method 5. Based on UE ID

A PRB resource for monitoring the sPDCCH may be determined according to an ID of the UE (e.g., C-RNTI). That is, a PRB location constituting a PRB-set may be determined according to the ID of the UE.

An embodiment of the present invention includes determining the PRB resource for monitoring the sPDCCH by one or two or more combinations of the proposed methods.

B. Flexible sPDCCH PRB Resource

As in Method 4 in Section C, a PRB and/or PRB group region in which the sPDSCH is transmitted may be determined according to a PRB region in which the sPDCCH is transmitted. For example, the size of the PRB in which the sPDSCH is transmitted may be determined according to an aggregation level (AL) or a PRB region in which the sPDCCH is transmitted. In this case, in order to determine the size of the PRB in which the sPDSCH is transmitted, i.e., the number of PRBs used to transmit the sPDSCH, it is considered that the number of PRBs used to transmit the sPDCCH becomes different. To vary the number of PRBs occupied by the sPDSCH according to a PRB region in which the sPDCCH is transmitted, an embodiment of the present invention proposes that the number of PRBs in which the sPDCCH is transmitted be different according to a decoding candidate of the sPDCCH monitored by the UE. In particular, the number of PRBs in which the sPDCCH is transmitted may differ according to a decoding candidate even between decoding candidates having the same AL.

Method 1. The number of PRBs to which CCEs constituting a decoding candidate belong may differ according to an sPDCCH decoding candidate. For example, when both decoding candidate #0 and decoding candidate #1 use 4 CCEs, decoding candidate #0 may be configured by 4 CCEs belonging to PRB #0 and PRB #1 but decoding candidate #1 may be configured by 4 CCEs belonging to PRB #0, PRB #1, PRB #2, and PRB #3. That is, although a part of the 4 CCEs constituting candidate #0 belong to PRB #0 and the other part of the 4 CCEs belong to PRB #1, the 4 CCEs constituting candidate #1 may belong to PRB #0, PRB #1, PRB #2, and PRB #3, respectively. In this case, decoding candidate #0 may be transmitted through PRB #0 and PRB #1, whereas decoding candidate #1 may be transmitted through PRBs #0, #1, #2, and #3.

Method 2. The number of PRBs to which REGs constituting CCEs belong may differ according to an sPDCCH decoding candidate. For example, both decoding candidate #0 and decoding candidate #1 may be configured using two CCEs (CCE #0 and CCE #1). However, in the case of CCEs constituting decoding candidate #0, CCE #1 may be configured by REGs present in PRB #0 to PRB #2 and CCE #2 may be configured by REGs present in PRB #3 to PRB #5. In the case of CCEs constituting decoding candidate #1, CCE #1 may be configured by REGs present in PRB #0 to PRB #5 and CCE #2 may be configured by REGs present in PRB #6 to PRB #11. In this case, decoding candidate #0 may be transmitted through PRBs #0 to #5, whereas decoding candidate #1 may be transmitted through PRBs #0 to #11.

Method 3. A plural number (e.g., 4) of sPDCCH PRB-sets in which the sPDCCH monitored by the UE is transmitted may be configured and each PRB-set may be configured by a different number of PRBs. In this case, assuming that the sPDCCH is transmitted through all (or some) PRB-sets constituting an sPDCCH PRB-set, the number of PRBs in which the sPDCCH is transmitted may differ according to the number of PRBs constituting the sPDCCH PRB-set.

According to Method 3, the UE may need to perform more trials of blind detection (BD) according to the number PRBs in which a decoding candidate is transmitted even with respect to the same AL. Accordingly, in order to reduce complexity of sPDCCH BD, an AL of the sPDCCH may be indicated through RRC or first DCI.

C. sPDSCH PRB Allocation

Hereinafter, methods of allocating a PRB region in which the sPDSCH is transmitted within an sTTI will be proposed.

Method 1. Allocation of sPDSCH within PRBs for sPDCCH PRB-Set

A PRB resource in which the sPDSCH can be scheduled may be limited to a PRB resource in which the sPDCCH can be transmitted or is transmitted. If the number of PRB-sets of the sPDCCH is plural, a PRB resource in which the sPDSCH can be scheduled may be limited to a PRB resource constituting a PRB-set in which DCI for scheduling the sPDSCH is transmitted. Alternatively, when the number of PRB-sets of the sPDCCH is plural, the sPDSCH may be scheduled in all PRB resources constituting the plural PRB-sets.

In this case, a PRB resource location in which the sPDSCH is transmitted within a corresponding PRB resource may be configured and PRB resource information for identifying the PRB resource location within the PRB resource may be transmitted through DCI or fast DCI.

Alternatively, (a) a PRB resource in which the sPDSCH is transmitted may be equal to all PRB resources constituting a PRB-set in which the sPDCCH for scheduling the sPDSCH is transmitted. Alternatively, (b) when the UE monitors multiple sPDCCH PRB-sets, a PRB resource in which the sPDSCH is transmitted may be equal to all PRB resources constituting PRB-sets for monitoring the sPDCCH. Alternatively, when the UE monitors multiple sPDCCH PRB-sets, whether a PRB resource in which the scheduled sPDSCH is transmitted corresponds to the method (a) or (b) may be configured through DCI, first DCI, or second DCI.

Method 2. Allocation of sPDSCH PRB within Restricted PRB Resource

A PRB resource in which the sPDSCH can be scheduled may be limited to a specific PRB resource. For example, the PRB resource in which the PDSCH can be scheduled may be fixed (in the standard specification) or configured through RRC by the eNB. Such RRC configuration may be transmitted to the UE through the sPDCCH and/or the legacy PDCCH.

A PRB resource location in which the sPDSCH is transmitted within a corresponding PRB resource may be configured and PRB resource information for identifying the PRB resource location within the PRB resource may be transmitted through the DCI or first DCI.

Method 3. Allocation of PDSCH PRB within Full PRBs

The sPDSCH may be flexibly scheduled within an entire system bandwidth.

Similarly to a legacy PDCCH/EPDCCH, a PRB resource location in which the sPDSCH is transmitted within all system bandwidth resources may be configured and PRB resource information for identifying the PRB resource location within the all system bandwidth resources may be transmitted through the DCI or first DCL

Method 4. sPDCCH Transmission PRBs

The sPDSCH may be transmitted using a PRB resource in which the sPDCCH for scheduling the sPDSCH is transmitted.

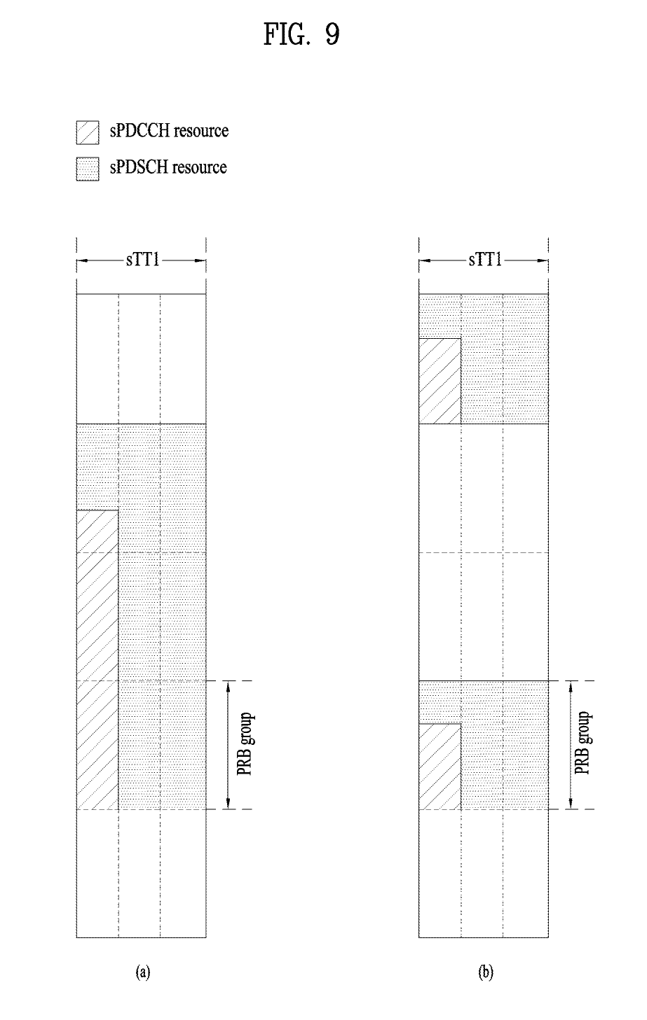

FIG. 9 illustrates a frequency resource for transmitting an sPDSCH according to an embodiment of the present invention.

The sPDSCH may be transmitted using a PRB group resource to which a PRB resource in which the sPDCCH for scheduling the sPDSCH is transmitted belongs. For example, as illustrated in FIGS. 9(a) and 9(b), the sPDSCH scheduled by the sPDCCH may be transmitted through the entire frequency region of a PRB group to which a PRB resource in which the sPDCCH for scheduling the sPDSCH is transmitted belongs.

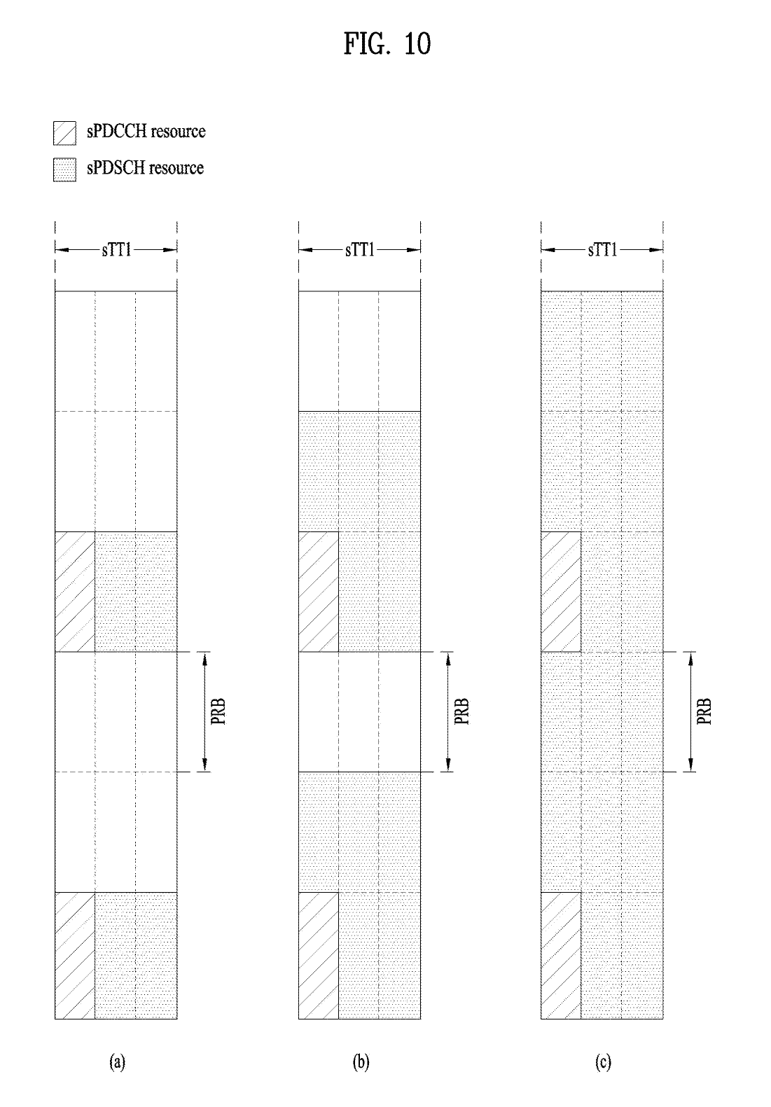

FIG. 10 illustrates a frequency resource for transmitting an sPDSCH according to another embodiment of the present invention.

A transmission resource of the sPDSCH may be determined using additional information which is indicated separately from a PRB resource in which an sPDCCH is transmitted. For example, if the sPDCCH is transmitted including PRB #m, the sPDSCH may be transmitted through PRBs (or PRB groups) #m, #m+1, #m+G−1. Herein, G may be fixed or may be configured through RRC or (first or second) DCI. For example, when the sPDCCH is transmitted through PRBs #0 and #3, the sPDSCH may be transmitted through PRBs #0 and #3 when G is 0, as illustrated in FIG. 10(a), the sPDSCH may be transmitted through PRBs #0, #1, #3, and #4 when G is 1, as illustrated in FIG. 10(b), and the sPDSCH may be transmitted through PRBs #0, #1, #2, #3, #4, and #5 when G is 2, as illustrated in FIG. 10(c).

Meanwhile, when a PRB resource for transmission of the sPDCCH is equal to or is associated with a PRB resource for transmission of the sPDSCH, the amount of the PRB resource for transmission of the sPDSCH may differ according to the amount of the PRB resource for transmission of the sPDCCH. To adjust the transmission resource of the sPDCCH/sPDSCH, the UE may attempt to blind-decode/detect the sPDCCH with respect to various sPDCCH ALs. However, to reduce complexity of blind-decoding/detection of the sPDCCH, an AL, which is the unit of a CCE/ECCE in which the UE performs blind-decoding/detection, may be indicated through RRC or first DCI.

Method 5. Dedicated PRB Resource for Each Decoding Candidate

With respect to each sPDCCH decoding candidate, an associated sPDSCH resource may be present and, according to a decoding candidate index of an sPDCCH for scheduling an sPDSCH, a PRB resource which is to receive the scheduled sPDSCH may be determined. An sPDSCH resource associated with an sPDCCH decoding candidate may be predefined (in the standard specification) or may be configured by an SIB, RRC, or first DCI. Alternatively, the sPDSCH resource associated with the sPDCCH decoding candidate may be determined by a specific equation. Alternatively, the number of PRBs/PRB groups and/or the locations of PRBs/PRB groups in which the PDSCH is transmitted may be determined according to the sPDCCH decoding candidate index. For example, if the sPDCCH is transmitted through candidate #0, the scheduled sPDSCH may be transmitted through one PRB group and, if the sPDCCH is transmitted through candidate #1, the scheduled sPDSCH may be transmitted through two PRB groups.

Method 6. Dedicated PRB Resource Depending on First CCE Index of sPDCCH

With respect to a CCE index, an associated sPDSCH resource may be present and, according to the first CCE index in which an sPDCCH for scheduling an sPDSCH is transmitted, a PRB resource in which the UE is to receive the scheduled sPDSCH may be determined. The location and amount of a PRB resource to which the sPDSCH is allocated may be determined according to the lowest CCE index of a DL grant sPDCCH. The sPDSCH resource associated with the first CCE index of the sPDCCH may be predefined (in the standard specification) or may be configured by an SIB, RRC, or first DCI. Alternatively, the sPDSCH resource associated with the first CCE index of the sPDCCH may be determined by a specific equation. Alternatively, the number of PRBs/PRB groups and/or the locations of PRBs/PRB groups in which the PDSCH is transmitted may be determined according to the first CCE index of the sPDCCH. For example, if CCE #0 is the first CCE of the sPDCCH, the scheduled sPDSCH may be transmitted through one PRB group and, if the sPDSCH is transmitted through CCE #1, the scheduled sPDSCH may be transmitted through two PRB groups. A relationship between the first CCE and the number of PRBs/PRB groups and/or the locations of PRBs/PRB groups in which the scheduled sPDSCH is transmitted may be differently defined according to an AL of the sPDCCH. For example, the number of PRBs/PRB groups and/or the locations of PRBs/PRB groups in which the PDSCH is transmitted may be determined according to the value of the “first CCE index/AL” in which the sPDCCH is transmitted.

Method 7. Resource Pattern Indication

To reduce the size of a resource allocation (RA) field of DCI, each value indicated by the RA field may mean a specific sPDSCH transmission resource pattern. For example, a pattern actually applied to an sPDSCH among 2^{N} sPDSCH transmission resource patterns may be indicated to the UE through N bits. Such an sPDSCH transmission resource pattern may indicate only a PRB resource region in which the sPDSCH is transmitted. Alternatively, the sPDSCH transmission resource pattern may indicate not only the PRB resource region in which the sPDSCH is transmitted but also a resource region in which the sPDSCH is transmitted within an OFDM symbol region in which the sPDCCH is transmitted in the PRB resource region in which the sPDSCH is transmitted.

For example, an sPDSCH transmission resource pattern meant by each value indicated by the RA field may be configured as follows. With respect to each PRB size (i.e., the number of PRBs), multiple (e.g., 2) PRB patterns may be present. A PRB size of the sPDSCH and one pattern index among a plurality of PRB patterns for the PRB size may be indicated through the RA field. A PRB pattern for each PRB size may be configured by multiple non-overlapping PRB patterns. In this case, the PRB size of the sPDSCH may be indicated through other methods rather than the RA field. For example, the PRB size of the sPDSCH may be determined according to an AL at which the sPDCCH is transmitted or may be configured for the HE through an RRC signal or a legacy PDCCH.

Each sPDSCH transmission resource pattern indicated by the RA field may be configured by an RRC layer. The UE may receive configuration information about the sPDSCH transmission resource pattern(s) through an RRC signal and determine that one of the sPDSCH transmission resource pattern(s) configured by the RRC signal is an sPDSCH transmission resource, based on the value of the RA field.

The present invention includes an embodiment for determining the PRB resource of the sPDSCH according to each of the proposed methods or two or more combinations of the proposed methods.

D. Starting OFDM Symbol Location of sPDSCH Transmission

A PRB or an RB mentioned in the embodiments of the present invention may indicate a new PRB (hereinafter, sPRB) or RB (hereinafter, sRB) defined within an sTTI. The sPRB may be configured by OFDM symbol(s) within the sTTI in the time domain and 12*X subcarriers in the frequency domain, i.e., a frequency resource obtained by adding X legacy PRBs. When the number of OFDM symbols constituting the sTTI is T, the value of X may be equal to 12/T or 14/T.

A resource constituting an sPRB/sRB for transmission of an sPDCCH and a resource constituting an sPRB/sRB for transmission of an sPDSCH may differ. For example, an sPRB for the sPDSCH (hereinafter, sPRB_sPDSCH) may be configured by OFDM symbol(s) within the sTTI in the time domain and 12*X subcarriers in the frequency domain. If the number of OFDM symbols constituting the sTTI is T, the value of X may be equal to 12/T or 14/T. Meanwhile, an sPRB for the sPDCCH (hereinafter, sPRB_sPDCCH) may be configured by OFDM symbols region in the time domain, in which the sPDCCH can be transmitted, and 12/T or 14/r in the frequency domain.

The sPDCCH may be transmitted within the sTTI through front OFDM symbol(s) among OFDM symbols constituting the sTTI. Alternatively, the sPDCCH and the sPDSCH may be transmitted using the same OFDM symbol(s) within the sTTI. In this case, the present invention proposes a method of determining the location of an OFDM symbol on which transmission of the sPDSCH is started. Herein, the location of an OFDM symbol on which transmission of the sPDSCH is ended may be the location of the last OFDM symbol constituting the sTTI.

When the sPDSCH is transmitted only within a PRB region in which the sPDCCH can always be transmitted/is always transmitted, the location of a starting OFDM symbol for transmission of the sPDSCH may always be equal to the next OFDM symbol of the last OFDM symbol for transmission of the sPDCCH. However, as proposed in Method 2 or Method 3 of Section C, if the sPDSCH could be transmitted in a region other than the PRB region in which the sPDCCH can be transmitted/is transmitted, the location of an OFDM symbol on which transmission of the sPDSCH is started may be determined using the following methods. Alternatively, when a PRB region in which the sPDSCH can be transmitted/is transmitted overlaps a PRB region in which the sPDCCH can be transmitted/is transmitted, the starting location of transmission of the sPDSCH may be determined as follows.

The sPDCCH mentioned in Section D may mean an sPDCCH including both a DL grant and a UL grant. Alternatively, the sPDCCH may mean only an sPDCCH which carries the DL grant and may not mean an sPDCCH which carries the UL grant.

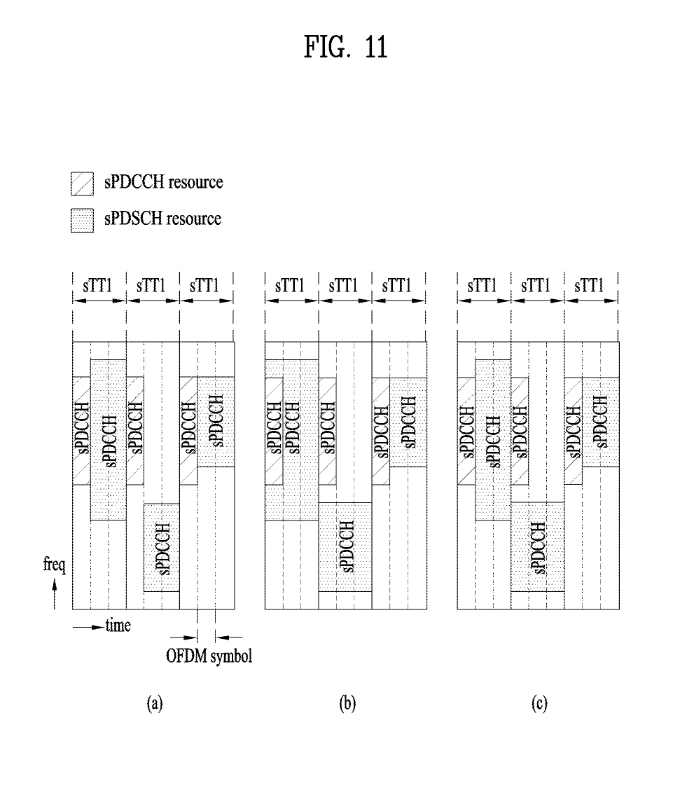

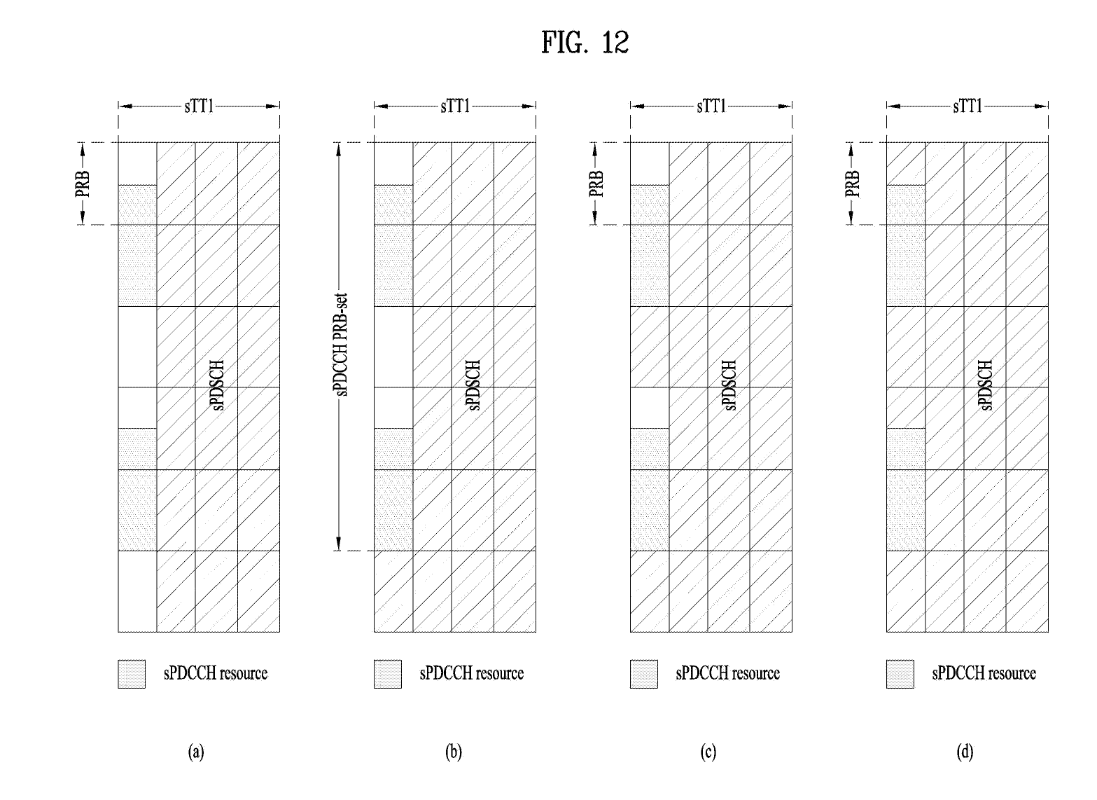

FIGS. 11 and 12 illustrate time resources for transmission of an sPDSCH.

Method 1. Transmission Through OFDM Symbol on which sPDCCH is not Transmitted

As illustrated in FIG. 11(a) or 12(a), an sPDSCH within an sTTI may always be transmitted using only OFDM symbols on which an sPDCCH is not transmitted. That is, the location of an OFDM symbol on which transmission of the sPDSCH is started may always be the same as the next OFDM symbol of the last OFDM symbol on which the sPDCCH is transmitted. In this case, even when the sPDSCH is transmitted only in a PRB region in which the sPDCCH is not transmitted, the location of an OFDM symbol on which transmission of the sPDSCH is started may always be the same as the next OFDM symbol of the last OFDM symbol on which the sPDCCH is transmitted.

Alternatively, the location of an OFDM symbol location on which transmission of the sPDSCH is started may be configured by the eNB through RRC, DCI, or a PCFICH and the UE may assume that the sPDSCH is transmitted starting from the configured OFDM symbol location in all PRB regions.

Method 2. Transmission Only in OFDM Symbol Region in which sPDCCH is not Transmitted within sPDCCH PRB-Set(s)

As illustrated in FIG. 11(b) or 12(b), transmission of the sPDSCH may be started from the first OFDM symbol location within an sTTI. However, in a PRB region in which the sPDCCH is transmitted or can be transmitted, transmission of the sPDSCH may be performed starting from the next OFDM symbol of the last OFDM symbol on which the sPDCCH is transmitted. The PRB region in which the sPDCCH can be transmitted refers to an sPDCCH PRB-set, i.e., a PRB region in which the UE monitors the sPDCCH. For example, in the PRB region in which the sPDCCH can be transmitted (i.e., a PRB region constituting a PRB-set of the sPDCCH or a PRB region constituting an sPDCCH search space), the starting OFDM symbol location of transmission of the sPDSCH may always be the same as the next OFDM symbol of the last OFDM symbol of transmission of the sPDCCH and, in the other PRB regions, the starting OFDM symbol location of transmission of the sPDSCH may be the same as the first OFDM symbol within an sTTI.

When there are multiple PRB-sets of the sPDCCH, the starting OFDM symbol location of transmission of the sPDSCH in a PRB region of all PRB-sets may always be the same as the next OFDM symbol of the last OFDM symbol of transmission of the sPDCCH and the starting OFDM symbol location of transmission of the sPDSCH in the other PRB regions may be the same as the first OFDM symbol within an sTTI.

In an sPRB_sPDSCH region overlapping an sPRB_sPDCCH region in which the sPDCCH can be transmitted (i.e., a sPRB_sPDCCH region constituting an sPRB_sPDCCH-set of the sPDCCH or an sPRB_PDCCH region constituting an sPDCCH search space), the starting OFDM symbol location of transmission of the sPDSCH may always be the same as the next OFDM symbol of the last OFDM symbol of transmission of the sPDCCH and, in the other sPRB-sPDSCH regions, the starting OFDM symbol location of transmission of the sPDSCH may be the same as the first OFDM symbol within an sTTI.

An sPDSCH starting OFDM symbol location within an sPDCCH PRB-set in which the UE monitors the sPDCCH or an sPDSCH starting OFDM symbol location within an sPRB_sPDSCH region overlapping an sPDCCH sPRB_sPDCCH-set in which the UE monitors the sPDCCH) may be as follows.
Option 1. The sPDSCH transmission starting OFDM symbol location may be fixed to the next OFDM symbol of the last sPDCCH transmission OFDM symbol.
Option 2. The sPDSCH transmission starting OFDM symbol location may be semi-statically configured by the eNB through an SIB and/or an RRC signal.
Option 3. The sPDSCH transmission starting OFDM symbol location may be semi-statically configured by the eNB through an SIB and/or an RRC signal.
Option 4. The sPDSCH transmission starting OFDM symbol location may be dynamically configured by the eNB through a PCFICH transmitted within an sTTI in which the sPDSCH is received.
Option 5. The sPDSCH transmission starting OFDM symbol location may be dynamically configured by the eNB through DCI for scheduling the sPDSCH.

An sPDSCH starting OFDM symbol location in a PRB location other than the sPDCCH PRB-set in which the UE monitors the sPDCCH or an sPDSCH starting OFDM symbol location in an sPRB_sPDSCH location which does not overlap an sPDCCH sPRB_sPDCCH-set in which the UE monitors the sPDCCH may be as follows.
Option 1. The sPDSCH transmission starting OFDM symbol location may be fixed to the first OFDM symbol of an sTTI.
Option 2. The sPDSCH transmission starting OFDM symbol location may be semi-statically configured by the eNB through an SIB and/or an RRC signal.
Option 3. The sPDSCH transmission starting OFDM symbol location may be configured by the eNB through the DCI transmitted on a legacy PDCCH.
Option 4. The sPDSCH transmission starting OFDM symbol location may be dynamically configured by the eNB through a PCFICH transmitted within an sTTI in which the sPDSCH is received.
Option 5. The sPDSCH transmission starting OFDM symbol location may be dynamically configured by the eNB through DCI for scheduling the sPDSCH.

Method 3. Transmission of sPDSCH Only in OFDM Symbol Region in which sPDCCH is not Transmitted in all PRBs when sPDSCH Transmission PRB Resource Overlaps sPDCCH PRB-Set(s)

As illustrated in 11(c), transmission of the sPDSCH may be started from the first OFDM symbol location within an sTTI. However, when all or some of a PRB region in which the sPDSCH is transmitted overlaps a PRB region in which the sPDCCH is transmitted or can be transmitted (i.e., a PRB region in which the UE monitors the sPDCCH), the sPDSCH may be transmitted starting from the next OFDM symbol of the last OFDM symbol of transmission of the sPDCCH. That is, if the PRB region in which the sPDSCH is transmitted overlaps the PRB region in which the sPDCCH can be transmitted (i.e., a PRB region constituting a PRB-set of the sPDCCH or a PRB region constituting an sPDCCH search space), an sPDSCH transmission starting OFDM symbol location may always be equal to the next OFDM symbol of the last OFDM symbol of transmission of the sPDCCH. However, if the PRB region in which the sPDSCH is transmitted does not overlap the PRB region in which the sPDCCH can be transmitted (i.e., a PRB region constituting a PRB-set of the sPDCCH or a PRB region constituting the sPDCCH search space), the sPDSCH transmission starting OFDM symbol location may be equal to the first OFDM symbol within an sTTI.

When multiple PRB-sets of the sPDCCH are present, if a PRB region in which the sPDSCH is transmitted overlaps a PRB region constituting at least one sPDCCH PRB-set, the PDSCH transmission starting OFDM symbol location may always be equal to the next OFDM symbol of the last OFDM symbol of transmission of the sPDCCH. However, if the PRB region in which the sPDSCH is transmitted does not overlap the PRB region constituting an sPDCCH PRB-set with respect to all sPDCCH PRB-sets, the sPDSCH transmission starting OFDM symbol location may be equal to the first OFDM symbol within an sTTI.

When an sPRB_sPDCCH region in which the sPDCCH can be transmitted (i.e., an sPRB_sPDCCH region constituting an sPRB_sPDCCH-set of the sPDCCH or an sPRB_PDCCH region constituting an sPDCCH search space) overlaps an sPRB_sPDSCH region in which the sPDSCH is transmitted, the sPDSCH may be transmitted starting from the next OFDM symbol of the last OFDM symbol of transmission of the sPDCCH.

Method 4. Transmission Only in OFDM Symbol Region in which sPDCCH is not Transmitted in PRB Region in which sPDCCH for Scheduling sPDSCH is Transmitted

As illustrated in FIG. 12(c), transmission of an sPDSCH in a PRB region in which an sPDCCH for scheduling the sPDSCH is transmitted may differ from transmission of the sPDCCH in the other PRB regions. For example, in the PRB region in which the sPDCCH for scheduling the sPDSCH is transmitted, the sPDSCH may be transmitted on the next OFDM symbol of the last OFDM symbol on which the sPDCCH can be transmitted and, in the other PRB regions, the sPDSCH may be transmitted on the first OFDM symbol.

In an sPRB_sPDSCH region overlapping an sPRB_sPDCCH region in which the sPDCCH for scheduling the sPDSCH is transmitted, an sPDSCH transmission starting OFDM symbol location may always be equal to the next OFDM symbol of the last OFDM symbol of transmission of the sPDCCH and, in the other sPRB_sPDSCH regions, the sPDSCH transmission starting OFDM symbol location may be equal to the first OFDM symbol within an sTTI.

In a PRB in which the sPDCCH for scheduling the sPDSCH is transmitted or an sPRB_sPDSCH region overlapping an sPRB_sPDCCH region in which the sPDCCH for scheduling the sPDSCH is transmitted, an sPDSCH starting OFDM symbol location may be as follows.
Option 1. The sPDSCH transmission starting OFDM symbol location may be fixed to the next OFDM symbol of the last OFDM symbol on which the sPDCCH can be transmitted.
Option 2. The sPDSCH transmission starting OFDM symbol location may be fixed to the next OFDM symbol of the last OFDM symbol on which the sPDCCH for scheduling the sPDSCH is transmitted.
Option 3. The sPDSCH transmission starting OFDM symbol location may be semi-statically configured by the eNB through an SIB and/or an RRC signal.
Option 4. The sPDSCH transmission starting OFDM symbol location may be configured by the eNB through DCI transmitted on a legacy PDCCH.
Option 5. The sPDSCH transmission starting OFDM symbol location may be dynamically configured by the eNB through a PCFICH transmitted within an sTTI in which the sPDSCH is received.
Option 6. The sPDSCH transmission starting OFDM symbol location may be dynamically configured by the eNB through the DCI for scheduling the sPDSCH.

In a PRB region other than a PRB in which the sPDCCH for scheduling the sPDSCH is transmitted or an sPRB_sPDSCH region which does not overlap an sPRB_sPDCCH region in which the sPDCCH for scheduling the sPDSCH is transmitted, the sPDSCH starting OFDM symbol location may be as follows.
Option 1. The sPDSCH transmission starting OFDM symbol location may be fixed to the first OFDM symbol of an sTTI.
Option 2. The sPDSCH transmission starting OFDM symbol location may be semi-statically configured by the eNB through an SIB and/or an RRC signal.
Option 3. The sPDSCH transmission starting OFDM symbol location may be configured by the eNB through DCI transmitted on a legacy PDCCH.
Option 4. The sPDSCH transmission starting OFDM symbol location may be dynamically configured by the eNB through a PCFICH transmitted within an sTTI in which the sPDSCH is received.
Option 5. The sPDSCH transmission starting OFDM symbol location may be dynamically configured by the eNB through DCI for scheduling the sPDSCH.

Method 5. Transmission of sPDSCH in RE Region in which sPDCCH for Scheduling sPDSCH is not Transmitted

As illustrated in FIG. 12(d), an sPDSCH may be transmitted in an RE region in which an sPDCCH for scheduling the sPDSCH is not transmitted. That is, the sPDSCH may be transmitted even in a PRB in which the sPDCCH for scheduling the sPDSCH is transmitted and the sPDSCH may be transmitted in an RE region in which the sPDCCH is not transmitted within the PRB. In the RE region in which the sPDCCH is transmitted, transmission of the sPDSCH may be rate-matched or punctured. That is, the sPDSCH may not be mapped in REs in which the sPDCCH is transmitted so as to be rate-matched. Alternatively, the sPDSCH may be mapped in REs in which the sPDCCH is transmitted but an sPDSCH signal mapped to the REs in which the sPDCCH is transmitted may be punctured.

Method 6. Transmission Only in OFDM Symbol Region in which sPDCCH is not Transmitted in PRB Region Indicated by eNB

The UE may receive configuration of information about a PRB location used to transmit the sPDCCH (or information about a PRB location which is not used to transmit the sPDCCH) for the eNB. Such configuration information may be dynamically configured for the UE through DCI. The PRB may refer to an sPRB or sPRB_sPDSCH.

An sPDSCH starting OFDM symbol location within a PRB region used to transmit the sPDCCH determined by the configuration information may be as follows.
Option 1. The sPDSCH transmission starting OFDM symbol location may be fixed to the next OFDM symbol of the last OFDM symbol on which the sPDCCH can be transmitted.
Option 2. The sPDSCH transmission starting OFDM symbol location may be fixed to the next OFDM symbol of the last OFDM symbol on which the sPDCCH for scheduling the sPDSCH is transmitted.
Option 3. The sPDSCH transmission starting OFDM symbol location may be semi-statically configured by the eNB through an SIB and/or an RRC signal.
Option 4. The sPDSCH transmission starting OFDM symbol location may be configured by the eNB through DCI transmitted on a legacy PDCCH.
Option 5. The sPDSCH transmission starting OFDM symbol location may be dynamically configured by the eNB through a PCFICH transmitted within an sTTI in which the sPDSCH is received.
Option 6. The sPDSCH transmission starting OFDM symbol location may be dynamically configured by the eNB through the DCI for scheduling the sPDSCH.

An sPDSCH starting OFDM symbol location within a PRB region which is not used to transmit the sPDCCH determined by the configuration information may be as follows.
Option 1. The sPDSCH transmission starting OFDM symbol location may be fixed to the first OFDM symbol of an sTTI.
Option 2. The sPDSCH transmission starting OFDM symbol location may be semi-statically configured by the eNB through an SIB and/or an RRC signal.
Option 3. The sPDSCH transmission starting OFDM symbol location may be configured by the eNB through DCI transmitted on a legacy PDCCH.
Option 4. The sPDSCH transmission starting OFDM symbol location may be dynamically configured by the eNB through a PCFICH transmitted within an sTTI in which the sPDSCH is received.
Option 5. The sPDSCH transmission starting OFDM symbol location may be dynamically configured by the eNB through DCI for scheduling the sPDSCH.

The first OFDM symbol for transmitting the sPDSCH may be configured for the UE by providing the UE with information about a PRB location in which transmission of the sPDSCH can be started from the first OFDM symbol or information about a PRB location in which transmission of the sPDSCH should be performed in an OFDM symbol region in which the sPDCCH is not transmitted. Such configuration information may be dynamically transmitted to the UE through (E)PDCCH/sPDCCH DCI or through DCI for scheduling the sPDSCH. An sPDSCH starting OFDM symbol location in a PRB region in which transmission of the sPDSCH should be performed in an OFDM symbol region in which the sPDCCH is not transmitted may be as follows.
Option 1. The sPDSCH transmission starting OFDM symbol location may be fixed to the next OFDM symbol of the last OFDM symbol on which the sPDCCH can be transmitted.
Option 2. The sPDSCH transmission starting OFDM symbol location may be fixed to the next OFDM symbol of the last OFDM symbol on which the sPDCCH for scheduling the sPDSCH is transmitted.
Option 3. The sPDSCH transmission starting OFDM symbol location may be semi-statically configured by the eNB through an SIB and/or an RRC signal.
Option 4. The sPDSCH transmission starting OFDM symbol location may be configured by the eNB through DCI transmitted on a legacy PDCCH.
Option 5. The sPDSCH transmission starting OFDM symbol location may be dynamically configured by the eNB through a PCFICH transmitted within an sTTI in which the sPDSCH is received.
Option 6. The sPDSCH transmission starting OFDM symbol location may be dynamically configured by the eNB through the DCI for scheduling the sPDSCH.

Specifically, the information about a PRB location used to transmit the sPDCCH (or information about a PRB location which is not used to transmit the sPDCCH) or the information about a PRB location in which transmission of the sPDSCH can be started from the first OFDM symbol (or information about a PRB location in which transmission of the sPDSCH should be performed in an OFDM symbol region in which the sPDCCH is not transmitted) may be provided to the UE using the following schemes.
Method 1. Information about a PRB location which is not used (or is used) to transmit the sPDCCH or a PRB location in which transmission of the sPDSCH can be started from the first OFDM symbol (or a PRB location in which transmission of the sPDSCH should be performed in an OFDM symbol region in which the sPDCCH is not transmitted), among PRBs in the entire system bandwidth or PRBs within an sPDCCH-PRB-set, may be transmitted. Such configuration information may be transmitted by a bitmap scheme. The configuration information may be dynamically transmitted to the UE through (E)PDCCH/sPDCCH DCI or through DCI for scheduling the sPDSCH.
Method 2. Among PRB groups in the entire system bandwidth or PRB groups within an sPDCCH-PRB-set, which are generated by dividing PRBs in the entire system bandwidth or PRBs in the sPDCCH-PRB-set into a plurality of groups, information about a PRB group location which is not used (or is used) to transmit the sPDCCH or a PRB group location in which transmission of the sPDSCH can be started from the first OFDM symbol (or a PRB group location in which transmission of the sPDSCH should be performed in an OFDM symbol region in which the sPDCCH is not transmitted) may be transmitted. Such configuration information may be transmitted by a bitmap scheme. The configuration information may be dynamically transmitted to the UE through (E)PDCCH/sPDCCH DCI or through DCI for scheduling the sPDSCH.
Method 3. When multiple sPDCCH PRB-sets that the UE monitors are present, information about an sPDCCH PRB-set which is not used (or is used) to transmit the sPDCCH or an sPDCCH PRB-set in which transmission of the sPDSCH can be started from the first OFDM symbol (or an sPDCCH PRB-set in which transmission of the sPDSCH should be performed in an OFDM symbol region in which the sPDCCH is not transmitted), among sPDCCH PRB-sets, may be transmitted. For example, whether each sPDCCH PRB-set that the UE monitors has been used or has not been used to transmit the sPDCCH may be indicated to the UE. Such configuration information may be dynamically transmitted to the UE through (E)PDCCH/sPDCCH DCI or through DCI for scheduling the sPDSCH.

An RS for demodulating the sPDSCH may be present even in an OFDM symbol region in which the sPDCCH can be transmitted. In this case, the RS for demodulating the sPDSCH within each PRB/sPRB/sPRB_sPDSCH region in which the sPDSCH is transmitted may be transmitted only in a region which is present after an OFDM symbol location in which transmission of the sPDSCH is started. That is, an RS for demodulating the sPDSCH, located in a resource region which is not included in a PRB/sPRB/sPRB_sPDSCH and an OFDM symbol region in which the sPDSCH is transmitted, may be punctured (or rate-matched) and may not be transmitted.
E. Multiplexing of sPDCCH and sPDSCH

In section E, a method of multiplexing an sPDCCH and an sPDSCH is proposed when a PRB resources on which the sPDCCH and the sPDSCH received by the UE are transmitted overlap.

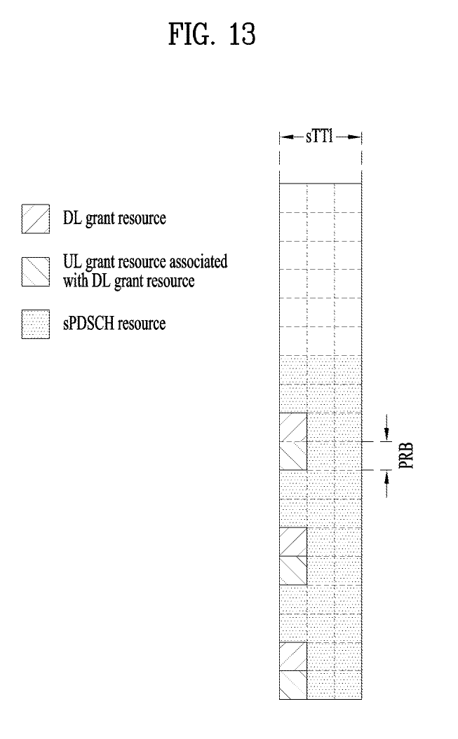

FIG. 13 illustrates multiplexing of an sPDCCH and an sPDSCH according to an embodiment of the present invention.

The UE may receive an sPDCCH for scheduling DL data (hereinafter, a DL grant or a DL grant sPDCCH) and an sPDCCH for scheduling UL data (hereinafter, a UL grant or a UL grant sPDCCH) within one sTTI. The UE may also receive an sPDSCH carrying the DL data within the sTTI in which the sPDCCH for scheduling the DL data is received. When the DL grant sPDCCH, the scheduled sPDSCH, and the UL grant sPDCCH are present within one sTTI, a PRB region in which the scheduled sPDSCH is received may overlap a transmission resource region of the received sPDCCH(s). In this case, an sPDSCH reception operation of the UE may be as follows.

DL Grant and Determination of sPDSCH Transmission Resource Considering UL Grant

When a resource on which the received DL grant and UL grant are transmitted overlaps a transmission resource of the sPDSCH, the UE may rate-match or puncture transmission of the sPDSCH in the overlapping RE, PRB, or PRB group resource.

Although the eNB has transmitted the DL grant, there is a possibility that the UE determines that the eNB has not transmitted the DL grant. On the contrary, there is a possibility that the UE determines that the UE has received the DL grant which has not been transmitted by the eNB. Since successful reception of the sPDSCH is based on successful reception of the DL grant, there is a low possibility that a detection error of the DL grant results in a detection error of the sPDSCH. For example, if the UE determines that the UE has received the DL grant although the eNB has not transmitted the DL grant, the UE will fail to receive the sPDSCH. Accordingly, upon determining a transmission resource of the sPDSCH, a detection error possibility of the DL grant sPDCCH need not be considered. Although the eNB has transmitted the UL grant, there is a possibility that the UE determines that the eNB has not transmitted the UL grant. On the contrary, there is a possibility that the UE determines that the UE has received the UL grant which has not been transmitted by the eNB. As opposed in the DL grant, in the case of the UL grant, a transmission resource of the sPDSCH may be incorrectly determined due to a detection error of the UL grant. A resource which is misunderstood by the UE as a UL grant sPDCCH may actually be a resource on which the eNB has transmitted the sPDSCH or a resource which is misunderstood by the UE as an sPDSCH resource may actually be a UL grant sPDSCH resource. Thereby, in some cases, the UE may fail to receive the sPDSCH which might have successfully been received if the UE correctly determined a transmission resource of the sPDSCH. For example, in the case in which the UE incorrectly determines that a resource which has not been used for UL grant transmission is a UL grant resource, if the UE rate-matches the sPDSCH on the UL grant resource, sPDSCH transmission recognized by the eNB and the UE becomes different and, therefore, the UE may not receive the sPDSCH. Unlike this, in the case in which the UE incorrectly determines that a resource which has not been used for UL grant transmission is a UL grant resource, if the UE punctures the sPDSCH on the incorrectly determined UL grant resource, the UE performs decoding without using some of all resources on which the sPDSCH has actually been transmitted and, therefore, there is a possibility that the UE successfully receives the sPDSCH.

In consideration of uncertainty of UL grant reception, the UE may rate-match the sPDSCH with respect to an RE, a PRB, or a PRB group resource of the sPDSCH overlapping an sPDCCH resource region in which the DL grant is transmitted but puncture the sPDSCH with respect to an RE, a PRB, or a PRB group resource of the sPDSCH overlapping an sPDCCH resource region in which the UL grant is transmitted. Then, even when the UE determines that the UL grant, which has actually not been transmitted, has been transmitted, a possibility of successfully receiving the sPDSCH may be raised.

An error may occur in determining a transmission resource of the sPDSCH by determining, by the UE, that the UL grant, which has actually not been transmitted, has been transmitted. To prevent this error, whether the UL grant is transmitted may be indicated to the UE within a corresponding sTTI through DCI for scheduling the sPDSCH (i.e., DL grant). In this case, although the DCI for scheduling the sPDSCH has indicated that the UL grant has been transmitted, the UE may fail to detect the UL grant. Then, the UE may 1) determine that the DCI for scheduling the sPDSCH is not valid, or 2) rate-match or puncture the sPDSCH in all resource regions in which the UL grant can be transmitted.

Referring to FIG. 8, the sPDSCH may not be mapped at all on a UL grant resource or may be mapped on up to the UL grant resource but a signal of the sPDSCH may be transmitted while the sPDSCH is punctured on the UL grant resource. The UE may decode or receive the sPDSCH under the assumption that the signal of the sPDSCH is not present (by being rate-matched or punctured) on the UL grant resource.

In this way, if a corresponding resource is rate-matched or punctured during reception of the PDSCH/sPDSCH regardless of whether the UL grant has actually been transmitted, waste of the resource may occur. However, a possibility that the PDSCH/sPDSCH is not successfully received because of incorrect determination of the PDSCH/sPDSCH is reduced. Since failure of PDSCH/sPDSCH reception may cause waste of more resources, resource allocation of the PDSCH/sPDSCH considering the UL grant may reduce waste of more resources.

UL Grant Resource Associated with DL Grant Resource

The UE may not receive the sPDSCH on many resources if rate-matching or puncturing the sPDSCH on all sPDCCH resources unnecessarily, on which the UL grant can be transmitted, in consideration of uncertainty of UL grant reception when the UE receives the sPDSCH. To solve such a problem, it is proposed that an sPDCCH resource location in which the UL grant can be transmitted be determined by an sPDCCH resource location in which the DL grant is transmitted. When both the DL grant and the UL grant are transmitted, the UL grant may be transmitted using a UL grant transmission sPDCCH resource associated with an sPDCCH transmission resource on which the DL grant is transmitted. According to an sPDCCH resource location or an sPDCCH decoding candidate index in which the DL grant is transmitted, one sPDCCH resource location (e.g., sPDCCH decoding candidate index) in which the UL grant can be transmitted to the UE may be determined. Alternatively, according to the sPDCCH resource location or the sPDCCH decoding candidate index in which the DL grant is transmitted, a plurality of sPDCCH resource locations (e.g., sPDCCH decoding candidate indexes) in which the UL grant can be transmitted to the UE may be determined. When the plural UL grant sPDCCH resource locations are determined, the UL grant may be transmitted in one resource location among the plural sPDCCH resource locations. For example, as illustrated in FIG. 8, a UL grant transmission sPDCCH resource associated with each sPDCCH resource on which the DL grant can be transmitted may be present. When both the DL grant and the UL grant are transmitted, the UL grant may be transmitted using a UL grant transmission sPDCCH resource associated with an sPDCCH transmission resource on which the DL grant is transmitted.

In consideration of uncertainty of UL grant reception, the UE may rate-match the sPDSCH with respect to an RE, a PRB, or a PRB group resource of the sPDSCH overlapping an sPDCCH resource region in which the DL grant is transmitted but puncture the sPDSCH with respect to an RE, a PRB, or a PRB group resource of the sPDSCH overlapping an sPDCCH resource region in which the UL grant is transmitted. Alternatively, the UE may rate-match the sPDSCH with respect to an RE, a PRB, or a PRB group resource of the sPDSCH overlapping an sPDCCH resource region in which the DL grant is transmitted and rate-match or puncture the sPDSCH with respect to an RE, a PRB, or a PRB group resource of the sPDSCH overlapping all of one or multiple sPDCCH resource regions in which the UL grant can be transmitted, regardless of whether the UL grant is transmitted or not.

An error may occur in determining a transmission resource of the sPDSCH by determining, by the UE, that the UL grant, which has actually not been transmitted, has been transmitted. To prevent this error, whether the UL grant is transmitted may be indicated to the UE within a corresponding sTTI through DCI for scheduling the sPDSCH. In this case, although the DCI for scheduling the sPDSCH has indicated that the UL grant has been transmitted, the UE may fail to detect the UL grant. Then, the UE may 1) determine that the DCI for scheduling the sPDSCH is not valid, or 2) rate-match or puncture the sPDSCH in all resource regions in which the UL grant can be transmitted.

Separate PRB Resource for DL Grant and UL Grant

In the case of the UL grant having uncertainty in reception, it may be difficult to determine whether the sPDSCH is transmitted on a transmission resource of the sPDSCH overlapping a UL grant transmission resource. Accordingly, to prevent an overlapping phenomenon between a UL grant transmission resource and an sPDSCH transmission resource, a frequency resource (e.g., PRB resource or a PRB group resource) on which the UL grant can be transmitted may be separated from a frequency resource on which the sPDSCH can be transmitted.

To this end, a PRB-set in which the UL grant can be transmitted may be distinguished from a PRB-set in which a DL grant can be transmitted. Alternatively, the DL grant and the UL grant may always be transmitted through different PRB-sets. This scheme may be more proper when a PRB resource on which the sPDSCH is transmitted is associated with a PRB resource on which the DL grant is transmitted, for example, when a PRB resource of the sPDSCH is included in a PRB resource on which the DL grant is transmitted and/or when the PRB resource of the sPDSCH includes the PRB resource on which the DL grant is transmitted. Alternatively, the UE may assume that the UL grant is not transmitted thereto through the PRB resource on which the sPDSCH is transmitted. For example, the UE may assume that the UL grant is not transmitted in an sPDCCH candidate or an sPDCCH PRB-set overlapping the PRB resource on which the sPDSCH is transmitted. Alternatively, for example, the UE may assume that sPDCCH transmission for UL grant transmission is rate-matched or punctured on an RE or a PRB resource on which the sPDSCH is transmitted.

When a PRB-set in which the UL grant can be transmitted is distinguished from a PRB-set in which the DL grant can be transmitted, if the sPDCCH resource on which the DL grant is transmitted overlaps an sPDSCH transmission resource, the sPDSCH on an RE resource on which the sPDCCH is transmitted may be rate-matched or punctured. However, if a PRB-set in which the UL grant can be transmitted overlaps the sPDSCH transmission resource, the sPDSCH on a PRB resource on which the UL grant can be transmitted may be rate-matched or punctured. This is because the UE ascertains transmission of the DL grant with respect to an RE resource on which the DL grant is transmitted but there is uncertainty as to whether the UL grant has really been transmitted to the UE with respect to the RE resource on which the UL grant is transmitted. In addition, since the UE cannot decode another UL grant transmitted to other UE(s), the UE is unaware of the amounts and locations of UL grant resources for other UE(s).

To aid in determining a resource on which the sPDSCH is transmitted, whether the UL grant is transmitted to the UE or whether the UL grant is transmitted to an arbitrary UE, within a corresponding sTTI, may be indicated through DCI for scheduling the sPDSCH. Herein, when the UL grant is not transmitted within a specific sTTI, it may be assumed that the sPDSCH is transmitted on a PRB resource on which the UL grant can be transmitted. When the UL grant is transmitted within the specific sTTI, it may be assumed that the sPDSCH is rate-matched or punctured on the PRB resource on which the UL grant can be transmitted.

In determining a transmission resource of the sPDSCH, a common search space (CSS) as well as a UL grant resource may be considered. The UE cannot determine whether the sPDCCH is transmitted in a CSS region. Accordingly, not only whether the UL grant resource is used for transmission of the sPDSCH but also whether the CSS region, i.e., a CSS resource, will be used for transmission of the sPDSCH may also be considered. An indication as to whether the UL grant, which is transmitted by the eNB to aid the UE in determining a resource on which the sPDSCH is transmitted, is transmitted may mean an indication as to whether the sPDSCH is transmitted on a resource and/or a CSS in which the UL grant is transmitted to the UE. In other words, indication information as to whether the UL grant is transmitted may be information indicating whether the sPDSCH for the UE is rate-matched or punctured in the UL grant resource and/or the CSS. Alternatively, a plurality of resource patterns in which the sPDSCH can be transmitted may be defined and pattern information indicating through which pattern among the plural patterns the sPDSCH is transmitted may be used as the indication information. The indication information indicating a resource pattern used for transmission of the sPDSCH may be transmitted through an explicit field in DCI, may be transmitted using an additional one or multiple bits in an RA field, or may be transmitted through the RA field.

For example, the UE may determine whether the UL grant is transmitted thereto (or whether the UL grant is transmitted to an arbitrary UE) or whether a control channel is transmitted in the CSS, through additional bit(s) in the RA field or of the explicit field of the DCI. This is the same meaning as an indication as to whether the sPDSCH is transmitted to the UE or an arbitrary UE on a UL grant resource or a CSS resource on which the UL grant is transmitted or can be transmitted.

As another example, the UE may be notified of a resource pattern actually occupied by the sPDSCH in a PRB region in which the sPDSCH is transmitted through additional bit(s) in the RA field or of the explicit field of the DCI. For example, when the size of a corresponding bit in the DL grant is 1 bit, if the bit is set to 0, this may mean that only RE, REG, or CCE resource(s) used to transmit the DL grant for scheduling the sPDSCH are not used to transmit the sPDSCH. If the bit is set to 1, this may mean an RE/REG/CCE resource having the same amount as an RE/REG/CCE resource on which the DL grant for scheduling the sPDSCH is transmitted is additionally not used to transmit the sPDSCH. Such additional resource locations may be equal to the next RE, REG, or CCE resources of the RE, REG, or CCE resources used for transmission of the DL grant.

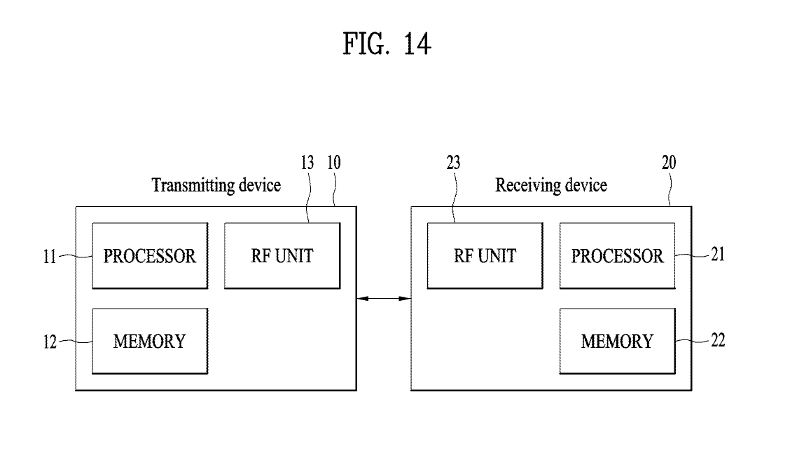

FIG. 14 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nᵢ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

The eNB processor and the UE processor of the present invention are configured to allocate/decode a signal within an sTTI which is shorter than a legacy TTI. The sTTI may consist of OFDM symbols. Since the sTTI is configured within the legacy TTI, a signal transmitted/received based on the legacy TTI and a signal transmitted/received based on the sTTI may simultaneously occur in the time domain.

The eNB processor of the present invention may generate DCI (e.g., DL grant or UL grant) according to any one of the embodiments proposed in Section A to Section E. The eNB processor may control the eNB RF unit to transmit a PDCCH and/or an sPDCCH carrying the DCI within a subframe or the sTTI according to any one of the embodiments proposed in Section A to Section E. The eNB processor may control the eNB RF unit to transmit a PDSCH/sPDSCH within the subframe or the sTTI according to the DL grant. The eNB processor may control the eNB RF unit to receive a PUSCH/sPUSCH within the subframe or the sTTI according to the UL grant. The subframe/sTTI in which the DL grant is transmitted may be equal to the subframe/sTTI in which the PDSCH/sPDSCH corresponding to the DL grant is transmitted. The subframe/sTTI in which the UL grant is transmitted may be different from the subframe/sTTI in which the PUSCH/sPUSCH corresponding to the UL grant is received. A difference between a UL grant transmission timing and a reception timing of the corresponding PUSCH/sPUSCH may be a multiple of a predefined integer of the subframe/sTTI. The eNB processor may rate-match or puncture the PDSCH/sPDSCH on a specific resource (e.g., UL grant resource or UL grant candidate resource) according to an embodiment of the present invention.

The UE processor of the present invention may control the UE RF unit to receive the PDCCH and/or sPDCCH carrying the DCI (e.g., DL grant or UL grant) within the subframe or the sTTI according to any one of the embodiments proposed in Section A to Section E. The UE processor may control the UE RF unit to receive the PDSCH/sPDSCH within the subframe or the sTTI according to the DL grant. The UE processor may control the UE RF unit to transmit the PUSCH/sPUSCH within the subframe or the sTTI according to the UL grant. The subframe/sTTI in which the DL grant is received may be equal to the subframe/sTTI in which the corresponding PDSCH/sPDSCH is transmitted. The subframe/sTTI in which the UL grant is received may be different from the subframe/sTTI in which the corresponding PUSCH/sPUSCH is transmitted. A difference between a UL grant reception timing and a transmission timing of the corresponding PUSCH/sPUSCH may be a multiple of a predefined integer of the subframe/sTTI. The UE processor may exclude a signal received on a specific resource from a decoding procedure of the PDSCH/sPDSCH under the assumption that the PDSCH/sPDSCH is rate-matched or punctured on the specific resource (e.g., UL grant resource or UL grant candidate resource) and then is transmitted according to an embodiment of the present invention.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a BS, a UE, or other devices in a wireless communication system.

1. A method of receiving control information by a user equipment (UE), the method comprising:
receiving a downlink grant in a subframe n; and
receiving downlink data in the subframe n according to the downlink grant,
wherein the downlink grant includes uplink grant information indicating whether or not an uplink grant is present, and
if the uplink grant information indicates that the uplink grant is present, the method further comprises attempting to detect the uplink grant in the subframe n.

2. The method according to claim 1, further comprising not attempting to detect the uplink grant in the subframe n if the uplink grant information indicates that the uplink grant is not present.

3. The method according to claim 1,
wherein the attempting to detect the uplink grant comprises:
attempting to detect the uplink grant within a candidate resource associated with a reception resource of the downlink grant.

4. The method according to claim 1, further comprising
determining that the downlink grant for scheduling the downlink data is not valid or rate-matching or puncturing the downlink data on a candidate resource of the uplink grant, if the uplink grant information indicates that the uplink grant is present but detection of the uplink grant fails.

5. The method according to claim 1,
wherein the subframe n is a shortened subframe consisting of partial orthogonal frequency division multiplexing (OFDM) symbols among OFDM symbols within a subframe of 1 ms.

6. A user equipment (UE) for receiving control information, the UE comprising:
a radio frequency (RF) unit; and
a processor connected to the RF unit,
wherein the processor is configured to control the RF unit to receive a downlink grant in a subframe n, and control the RF unit to receive downlink data in the subframe n according to the downlink grant,
the downlink grant includes uplink grant information indicating whether or not an uplink grant is present, and
if the uplink grant information indicates that the uplink grant is present, the processor is configured to attempt to detect the uplink grant in the subframe n.

7. The UE according to claim 6, wherein the processor is configured not to attempt to detect the uplink grant in the subframe n if the uplink grant information indicates that the uplink grant is not present.

8. The UE according to claim 6,
wherein the processor is configured to attempt to detect the uplink grant within a candidate resource associated with a reception resource of the downlink grant.

9. The UE according to claim 6,
wherein the processor is configured to determine that the downlink grant for scheduling the downlink data is not valid or rate-match or puncture the downlink data on a candidate resource of the uplink grant, if the uplink grant information indicates that the uplink grant is present but detection of the uplink grant fails.

10. The UE according to claim 6,
wherein the subframe n is a shortened subframe consisting of partial orthogonal frequency division multiplexing (OFDM) symbols among OFDM symbols within a subframe of 1 ms.

11. A method of transmitting control information by a base station (BS), the method comprising:
transmitting a downlink grant in a subframe n to a user equipment (UE); and
transmitting downlink data in the subframe n to the UE according to the downlink grant,
wherein the downlink grant includes uplink grant information indicating whether or not an uplink grant is present, and
if the uplink grant information indicates that the uplink grant is present, the method further comprises transmitting the uplink grant to the UE in the subframe n.

12. The method according to claim 11, further comprising not transmitting the uplink grant in the subframe n if the uplink grant information indicates that the uplink grant is not present.

13. The method according to claim 11,
wherein the transmitting the uplink grant comprises:
transmitting the uplink grant within a candidate resource associated with a transmission resource of the downlink grant.

14. The method according to claim 11, further comprising
rate-matching or puncturing the downlink data on a candidate resource of the uplink grant.

15. The method according to claim 11, wherein the subframe n is a shortened subframe consisting of partial orthogonal frequency division multiplexing (OFDM) symbols among OFDM symbols within a subframe of 1 ms.

16. A base station (BS) for transmitting control information, the BS comprising:
a radio frequency (RF) unit; and
a processor connected to the RF unit,
wherein the processor is configured to control the RF unit to transmit a downlink grant in a subframe n to a user equipment (UE), and control the RF unit to transmit downlink data in the subframe n to the UE according to the downlink grant,
the downlink grant includes uplink grant information indicating whether or not an uplink grant is present, and
if the uplink grant information indicates that the uplink grant is present, the processor is configured to control the RF unit to transmit the uplink grant to the UE in the subframe n.

17. The BS according to claim 16, wherein the processor is configured to control the RF unit not to transmit the uplink grant in the subframe n if the uplink grant information indicates that the uplink grant is not present.

18. The BS according to claim 16, wherein the processor is configured to control the RF unit to transmit the uplink grant within a candidate resource associated with a transmission resource of the downlink grant.

19. The BS according to claim 16, wherein the processor is configured to rate-match or puncture the downlink data on a candidate resource of the uplink grant.

20. The BS according to claim 16, wherein the subframe n is a shortened subframe consisting of partial orthogonal frequency division multiplexing (OFDM) symbols among OFDM symbols within a subframe of 1 ms.
